(19) United States
(12) Patent Application Publication
(10) Pub. No.: US 2012/0018685 A1
(43) Pub. Date: Jan. 26, 2012

(54) Optical film, retardation film, polarizing plate, and liquid crystal display device

(75) Inventors: Yasuyuki Sasada, Kanagawa (JP); Mitsuo Osato, Kanagawa (JP); Fumitake Mitobe, Kanagawa (JP); Kunihiro Atsumi, Kanagawa (JP); Hiroyuki Kawanishi, Kanagawa (JP); Ryo Suzuki, Kanagawa (JP)

(73) Assignee: FUJIFILM Corporation, Tokyo (JP)

(21) Appl. No.: 13/137,068

(22) Filed: Jul. 19, 2011

(30) Foreign Application Priority Data
Jul. 20, 2010 (JP) 2010-163446
Jun. 17, 2011 (JP) 2011-135780

(51) Int. Cl. G02B 5/30; C08L 67/02; C08L 33/08; C08K 5/3462; C08L 33/10; C08L 1/10; C08K 5/3492

(52) U.S. Cl. 252/585

(57) ABSTRACT

An optical film contains a cellulose ester and more than 30% by mass, relative to the cellulose ester, of a condensation product of at least one polyhydric alcohol having an average of 2.01 or more carbon atoms and at least one polybasic acid having an average of 4.10 or more carbon atoms, and at least one of the at least one polyhydric alcohol contains at least three carbon atoms bonded together without being interrupted by any other atom.

### FIELD OF THE INVENTION

This invention relates to an optical film containing a cellulose ester that exhibits good adhesion to a polarizer and is capable of attachment directly to a polarizer, a retardation film using the optical film, and a reliable polarizing plate, liquid crystal panel, and liquid crystal display device (LCD) using the optical film.

### BACKGROUND OF THE INVENTION

Films of polymers typified by cellulose esters, polyesters, polycarbonates, cycloolefin polymers, vinyl polymers, and polyimides are used in silver halide photographic light-sensitive materials, retardation films, polarizing plates, and image display devices. Films prepared from these polymers are excellent in flatness and uniformity and are widely employed in optical applications.

Among them, a cellulose acylate film having an appropriate moisture permeability is capable of direct attachment to a polarizer comprising polyvinyl alcohol and iodine, which is the most common in the art, on the production line. Therefore, a cellulose acylate film, particularly a cellulose acetate film is widely used as a polarizer-protective film of a polarizing plate.

In using the film described in optical applications as, for example, a retardation film, a support of a retardation film, a protective film of a polarizing plate, and an LCD, to control the optical anisotropy of the film is a very important factor governing the display device performance, such as visibility. With the recent demand for viewing angle enhancement in LCDs, improvement of retardation compensation has been desired. Specifically, the retardation film disposed between a polarizer and a liquid crystal cell is required to have an appropriately controlled in-plane retardation value Re and retardation value Rth in the thickness direction (hereinafter referred to thickness direction retardation). For example, the retardation film for use in IPS mode LCDs, which are widespread in liquid crystal TV sets (hereinafter LC TVs), is required to have a reduced Re and Rth. In this connection, JP 2009-098674A discloses combining a cellulose acylate with at least 5% by mass of a polyester diol having a hydroxyl group at both terminals thereof. On the other hand, an increased Re and Rth are desirable for use in VA mode LCDs. Various approaches have been taken to achieve appropriate adjustment of Re and Rth, such as preparation of film materials, control of film formation, and film stretching (see, e.g., EP 0911656, JP 5-257014A, JP 2005-138358A and JP 2001-100039A).

It has come to be known that, as an LCD becomes thinner, circular unevenness of light is liable to occur on the display surface under a specific condition. While the mechanism of the occurrence of such light unevenness has not altogether been defined, one of the causes is a contact between a backlight member and a liquid crystal panel (LC panel), especially the polarizing plate on the backlight side of the panel. To address this problem, JP 2009-169393A proposes texturizing the surface of the backlight side protective film made of polyethylene terephthalate protecting the backlight side polarizer, thereby to prevent a contact with a backlight member and to prevent occurrence of light unevenness.

JP 2006-64803A, JP 2009-208476A and JP 2002-22956A each disclose a cellulose acylate film containing 10% to 30% by mass, relative to the cellulose acylate, of a polyester polyol obtained from a polyhydric alcohol and a polybasic acid.

### SUMMARY OF THE INVENTION

A polyethylene terephthalate protective film for a polarizer as used in JP 2009-169393A has poor processing properties in making a polarizing plate, tending to incur reduction of production rate of a polarizing plate. Moreover, to use a polarizing plate having a polyethylene terephthalate protective film in an LC panel has turned out to raise the problem that the polarizing plate may cause warpage of the LC panel or occurrence of light unevenness in the periphery of the display area.

To solve the problems of conventional techniques, the present inventors have studied to develop an optical film having good processability in the manufacture of polarizing plates and providing a polarizing plate which, when applied to LCDs, causes no circular or peripheral light unevenness on the display surface.

As a result of extensive investigations, the inventors have found that the processability problem in the manufacture of polarizing plates is solved by using an optical film containing a cellulose ester. With respect to the circular light unevenness problem, they have also found that occurrence of the unevenness easily perceptible when a display surface is seen from the front, i.e., from the direction normal to the display surface decreases when the elastic modulus, photoelasticity, thickness, and moisture absorption of the film are reduced, and occurrence of the unevenness easy to perceive when a display surface is seen from a direction oblique to the display surface decreases when the humidity dependence of Rth of the film is reduced. Among known techniques for reducing the humidity dependence of Rth of a cellulose ester film is incorporating 20% by mass or more of a polyhydric alcohol/polybasic acid condensation product into a cellulose ester as disclosed in JP 2006-64803A. However, the inventors' study has revealed that this film changes its Rth value when kept under a moist heat condition.

Accordingly, an object of the invention is to provide an optical film that diminishes light unevenness on the display surface of an LCD and has a moist heat-stable Rth value.

The object of the invention is accomplished by the provision of the following means:

(1) An optical film comprising a cellulose ester and a condensation product of at least one polyhydric alcohol having an average of 2.01 or more carbon atoms with at least one polybasic acid having an average of 4.10 or more carbon atoms. At least one polyhydric alcohol to be condensed with the polybasic acid contains at least three carbon atoms bonded together without being interrupted by any other atom. The condensation product is present in an amount more than 30% by mass relative to the cellulose ester.
(2) The optical film of (1) above, wherein at least one of the carbon atoms bonded to the hydroxyl groups of the polyhydric alcohol is a secondary or tertiary carbon atom.
(3) The optical film of (1) or (2) above, wherein the condensation product has a hydroxyl value of less than 40 mgKOH/g.
(4) The optical film of any of (1) to (3) above, further comprising a compound that improves moist heat stability of retardation.
(5) The optical film of (4) above, wherein the compound that improves moist heat stability of retardation is a compound having basicity.
(6) The optical film of (5) above, wherein the compound having basicity contains at least one basic functional group selected from the group consisting of primary amino, secondary amino, tertiary amino, quaternary ammonium, pyridyl, pyrimidinyl, pyrazinyl, guanidino, imino, imidazolyl, indole, and purine.
(7) The optical film of any one of (4) to (6) above, wherein the compound that improves moist heat stability of retardation comprises a compound represented by formula (1) or (2):

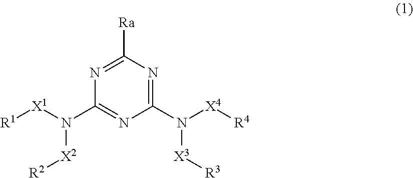

wherein Ra represents an optionally substituted alkyl group, an optionally substituted alkenyl group, an optionally substituted alkynyl group, an optionally substituted heterocyclic group, or an optionally substituted aryl group; X¹, X², X³, and X⁴ each independently represent a single bond or a divalent linking group; R¹, R², R³, and R⁴ each independently represent hydrogen, an optionally substituted alkyl group, an optionally substituted alkenyl group, an optionally substituted alkynyl group, an optionally substituted aryl group, an optionally substituted acyl group, or an optionally substituted heterocyclic group.

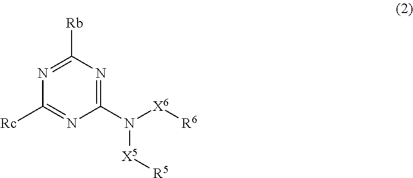

wherein Rb and Rc each independently represent an optionally substituted alkyl group, an optionally substituted alkenyl group, an optionally substituted alkynyl group, an optionally substituted heterocyclic group, or an optionally substituted aryl group; X⁵ and X⁶ each independently represent a single bond or a divalent linking group; and R⁵ and R⁶ each independently represent hydrogen, an optionally substituted alkyl group, an optionally substituted alkenyl group, an optionally substituted alkynyl group, an optionally substituted aryl group, an optionally substituted acyl group, or an optionally substituted heterocyclic group.
(8) The optical film according to any one of (1) to (7) above, further comprising an addition polymer of an acrylic ester or an addition polymer of a methacrylic ester.
(9) The optical film according to any one of (1) to (8) above, having a tensile elastic modulus of less than 3 GPa.
(10) The optical film according to any one of (1) to (9) above, having a ΔRth of from −30 to 30 nm, the ΔRth being defined by formula:

ΔRth=Rth(10%)−Rth(80%)

where Rth(H %) represents the Rth of the film measured at 25° C. and a relative humidity of H %.
(11) The optical film according to any one of (1) to (10) above, having a dimensional change of 3% or less when treated at 60° C. and 90% RH for one day.
(12) A retardation film comprising the optical film according to any one of (1) to (11) above.
(13) A polarizing plate including the optical film according to any one of (1) to (11) above or the retardation film according to (12) above.

An image display device including the optical film according to any one of (1) to (11) above, the retardation film according to (12) above, or the polarizing plate according to (13) above.

The optical film of the invention having a controlled retardation is useful in a polarizing plate, an LCD, and so forth. An LC panel and LCD having a retardation film or polarizing plate made by using the optical film of the invention have reduced occurrence of undesirable light unevenness on the display surface and exhibit high moist/heat-stability of Rth. The optical film of the invention exhibits good edge-cutting properties in the step of edge cutting.

### DETAILED DESCRIPTION OF THE INVENTION

The optical film of the invention essentially contains a cellulose ester and a condensation product of a polyhydric alcohol having an average of 2.01 or more carbon atoms with a polybasic acid having an average of 4.10 or more carbon atoms. The optical film contains the condensation product in an amount of more than 30% by mass relative to the cellulose ester. At least one polyhydric alcohol to be condensed with the polybasic acid contains at least three carbon atoms bonded together without being interrupted by any other atom.

Incorporating more than 30% by mass of a condensation product of the polyhydric alcohol and the polybasic acid to a cellulose ester provides an optical film with adequately controlled elastic modulus, photoelasticity, thickness, moisture absorption, and humidity dependence of Rth. As a result, using the optical film allows for elimination of the light unevenness problem with an LCD. The problem that the retardation varies when a film is placed in moist heat is settled by using a condensation product between a polyhydric alcohol having an average of 2.01 or more carbon atoms and a polybasic acid having an average of 4.10 or more carbon atoms and in which at least one polyhydric alcohol to be condensed with the polybasic acid contains at least three carbon atoms bonded together without being interrupted by any other atom. It should be noted, however, that the above described compound design can promote bleeding on the film surface. It is therefore advisable to minimize the amount or molecular weight of the condensation product to be added as long as the effects of the invention are obtained.

### [I] Condensation Product

The condensation product for use in the invention, which is a condensation product of one or more polyhydric alcohols having an average of 2.01 or more carbon atoms with one or more polybasic acids having an average of 4.10 or more carbon atoms in which at least one of the polyhydric alcohols contains at least three carbon atoms bonded together without being interrupted by any other atom, will be described in detail.

It is considered that a condensation product between a polyhydric alcohol having an average of 2.01 or more carbon atoms and a polybasic acid having an average of 4.10 or more carbon atoms hardly bleeds out and is effective in suppressing the retardation changes of a cellulose ester film maintained in moist heat.

When a film containing a large amount of a condensation product is kept under a moist heat condition, the condensation product will decompose and decrease in molecular weight thereby to gain migration properties. It would follow that the compound migrates to other materials in contact therewith, such as an adhesive, or bleeds out of the film. As a result, the amount of the condensation product in the film decreases, which seems to cause changes of retardation of the film. Such decomposition of a condensation product as described is markedly controlled by increasing the hydrophobicity of the ester bonds, enhancing the steric hindrance, or otherwise preventing depolymerization, thereby to reduce change of retardation. From this viewpoint, it is preferred for each of the polyhydric alcohol and the polybasic acid to have a greater average number of carbon atoms. In view of compatibility with a cellulose ester and reduction of humidity dependence of retardation, on the other hand, it is preferred that the polyhydric alcohol and the polybasic acid each have a smaller average number of carbon atoms and that the continuous carbon atoms contain a branched or cyclic structure. Accordingly, the average number of carbon atoms of the polyhydric alcohol is 2.01 or greater, preferably 2.05 to 10.00, more preferably 2.10 to 5.00, even more preferably 2.15 to 3.00, and most preferably 2.20 to 2.80. When, in particular, a weight is put on reduction of humidity dependence of retardation, it is preferably in the range of from 2.25 to 2.50. The average number of carbon atoms of the polybasic acid is 4.10 or greater, preferably 5.00 to 15.00, more preferably 5.50 to 10.00, even more preferably 6.00 to 8.00.

The average number of carbon atoms is obtained as an arithmetic average of the numbers of carbon atoms of all the polyhydric alcohols or polybasic acids constituting the condensation product. That is, the average number of carbon atoms is calculated by multiplying the number of carbon atoms of every alcohol or acid by the respective molar ratio and averaging all the products. For instance, a polyhydric alcohol comprising ethanediol and 1,2-propanediol in a molar ratio of 3/1 has an average of 2.25 carbon atoms.

At least one of the polyhydric alcohols making up the condensation product contains at least three carbon atoms bonded together without being interrupted by any other atom. To have continuously bonded three or more carbon atoms assures sufficient hydrophilicity, which is preferred for controlling changes of retardation of the film.

The proportion of the polyhydric alcohol having at least three carbon atoms bonded together without being interrupted by any other atom in all the polyhydric alcohols making up the condensation product is preferably 1 to 100 mol %, more preferably 10 to 100 mol %.

The polyhydric alcohol having at least three carbon atoms bonded together without being interrupted by any other atom contains a partial structure shown below in its molecule. In the structural formula shown below, the asterisk * indicates the bond to an atom. Examples of the polyhydric alcohol having at least three carbon atoms bonded together without being interrupted by any other atom include propanediol, butanediol, and dipropylene glycol.

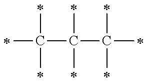

While the molecular weight of the condensation product for use in the invention is not particularly limited, it is preferably from 600 to 5000 in terms of average number molecular weight. By increasing the molecular weight of the condensation product within a range that does not harm the compatibility with a cellulose ester, the change of retardation observed when the film is kept in moist heat can be reduced. As a result, there is provided an LC panel that suffers from no deterioration in display characteristics even when an LCD is used in a severe environment.

Because the condensation product preferred in the invention has a primary structure acting to slightly reduce the compatibility, a low average molecular weight within the range recited above is recommended. The number average molecular weight (Mn) of the condensation product for use in the invention is preferably 600 to 3000, more preferably 650 to 2800, even more preferably 800 to 2000. With the Mn of at least 600, the condensation product has low volatility, which is advantageous to avoid occurrence of film defects or process contamination during film formation or film stretching under a high temperature condition. In addition, the changes of retardation observed when the film is kept in moist heat can be reduced by increasing the molecular weight of the condensation product. With the Mn of 5000 or less, the compatibility with a cellulose ester is secured, bleeding during film formation or stretching under heat are prevented. The statement relating to the molecular weight should not be interpreted as limiting the condensation product to a system consisting solely of a compound or compounds having a repeating unit, and the condensation product that can be used in the invention may be a mixture of such a compound having a repeating unit and a compound having no repeating unit.

The number average molecular weight of the condensation product may be determined by gel permeation chromatography.

Appropriately adjusting the number of carbon atoms of the polyhydric alcohol and/or the polybasic acid additionally produces a favorable effect that the film will exhibit improved edge-cutting properties in the step of edge cutting. With the improved edge cutting properties, the cut edges of the film have a smooth cut surface. As a result, the probability of the film being torn during transport decreases, and when the film is subjected to stretching, it exhibits improved stretchability. The improvement of the edge cutting properties also results in reduction of cutting dust, which reduces occurrence of a surface defect caused by adhesion of fine cutting dust to the film surface. While the mechanism by which the edge cutting properties are improved is still unclear, it appears that the effect is attributed to the fact that the condensation product having the above discussed preferred primary structure has an increased ratio of loss modulus to storage modulus compared with a condensation product having other primary structures. Specifically, in a film containing a condensation product in a large amount, the condensation product exists in microphase-separated domains and seems to fly apart on cutting the film edge to roughen the cut surface of the film or increase the cutting dust. It is considered that the viscosity of the condensation product may be increased by appropriately adjusting the number of carbon atoms of the polyhydric alcohol and/or the polybasic acid to be condensed, whereby the problems associated with edge cutting are settled.

The condensation product of the invention may be either liquid or solid at an ambient environmental temperature or humidity of use (generally at room temperature, i.e., 25° C. and 60% RH) but is preferably liquid in the environment of use from the standpoint of preventing bleeding. The condensation product preferably has no or little color and is more preferably colorless. The condensation product is preferably thermally stable at higher temperatures. Specifically, the condensation product preferably has a decomposition onset temperature of 150° C. or higher, more preferably 200° C. or higher.

The condensation product for use in the invention will further be described with reference to specific but non-limiting examples thereof.

### [I-1] Condensation Product of Polyhydric Alcohol and Polybasic Acid

The condensation product to be used in the invention is not particularly limited as long as it is obtained from one or more polyhydric alcohols having an average of 2.01 or more carbon atoms and one or more polybasic acids having an average of 4.10 or more carbon atoms. The condensation product is preferably obtained by the reaction between a dibasic acid a glycol. Both the terminals of the condensation reaction product obtained from a dibasic acid a glycol may be blocked by allowing the product to further react with a monocarboxylic acid or a monohydric alcohol. To use the resulting terminal-blocked condensation product allows for reducing the moisture absorption of the film. It will follow that the film has reduced humidity dependence of retardation and reduced changes of retardation when held in a moist heat environment. From the viewpoint of improving compatibility with a cellulose ester, it is preferred for the condensation product with its terminals blocked to have a reduced hydroxyl value as compared with a non-terminal-blocked condensation product. Specifically, the condensation product with both terminals blocked preferably has a hydroxyl value of 40 mgKOH/g or less, more preferably 20 mgKOH/g or less, even more preferably 10 mgKOH/g or less.

The polyhydric alcohol in the condensation product of the polyhydric alcohol and the polybasic acid preferably comprises a polyhydric alcohol with more than 2 carbon atoms.

The condensation product between the polyhydric alcohol and the polybasic acid is preferably synthesized from a glycol having 2 to 12 carbon atoms and a dibasic acid having 4 to 12 carbon atoms. It is particularly preferred that at least part of the condensation product be synthesized from a glycol with 3 to 12 carbon atoms and the dibasic acid.

The dibasic acid to be condensed with the polyhydric alcohol preferably includes a C4-C12 aliphatic or alicyclic dicarboxylic acid or a C8-C12 aromatic dicarboxylic acid. The glycol to be condensed with the dibasic acid preferably includes a C2-C12 aliphatic or alicyclic glycol and a C6-C12 aromatic glycol. Selection of the glycol and dibasic components to be condensed together is made as appropriate to the desired retardation. These glycols as well as the dibasic acids may be used either singly or in combination of two or more thereof. When, for example, a film with reduced retardation is desired, it is preferred to choose an aliphatic or alicyclic dicarboxylic acid or phthalic acid and an aliphatic or alicyclic glycol. When a film with increased retardation is wanted, a condensation product having an aromatic dicarboxylic acid residue and/or an aromatic glycol residue is preferred.

The dibasic acids and glycols that are preferably used to make the condensation product for use in the invention will then be described.

The dibasic acid may be aliphatic or aromatic. The dibasic acid preferably includes a dibasic acid having more than 4 carbon atoms from the viewpoint of improving retardation stability.

Examples of the aliphatic dicarboxylic acid include oxalic acid, malonic acid, succinic acid, maleic acid, fumaric acid, glutaric acid, adipic acid, suberic acid, azelaic acid, cyclohexanedicarboxylic acid, sebacic acid, and dodecanedicarboxylic acid, with succinic acid and adipic acid being particularly preferred in view of compatibility.

Examples of the aromatic dicarboxylic acids include phthalic acid, terephthalic acid, isophthalic acid, 1,5-naphthalenedicarboxylic acid, and 1,4-naphthalenedicarboxylic acid, with phthalic acid and terephthalic acid being preferred, and with terephthalic acid being particularly preferred.

The dibasic acid to be used in the invention preferably contains 4 to 12, more preferably 4 to 8, even more preferably 4 to 6, carbon atoms. Two or more dibasic acids may be used in combination, in which case a plurality of the dibasic acids preferably have an average number of carbon atoms within the range recited above. The number of the carbon atoms being in that range, the condensation product achieves not only reduction of light unevenness in application to image display devices but also hardly bleeds out during film formation or film stretching under heat owing to its good compatibility with a cellulose ester.

A combined use of an aliphatic dicarboxylic acid and an aromatic dicarboxylic acid is also preferred. Specifically, a combination of adipic acid and phthalic acid, a combination of adipic acid and terephthalic acid, a combination of succinic acid and phthalic acid, or a combination of succinic acid and terephthalic aid is preferred, with a combination of succinic acid and phthalic acid and a combination of succinic acid and terephthalic acid being more preferred. The aliphatic to aromatic dicarboxylic acid molar ratio is preferably, but not limited to, 95:5 to 40:60, more preferably 55:45 to 45:55.

The glycol (diol) may be aliphatic or aromatic, preferably aliphatic. To achieve improvement of stability of retardation when the film is kept in moist heat as contemplated by the invention, it is preferred that the glycol include a polyhydric alcohol with more than two carbon atoms and/or that at least one of the carbon atoms bonded to the hydroxyl groups of the polyhydric alcohol is a secondary or tertiary carbon atom. It is considered that decomposition of the condensation product in moist heat is prevented by putting the carbon atom in a hydrophobic environment, thereby to reduce the changes of retardation in moist heat.

The aliphatic group of the aliphatic diol may be straight chain, branched, or cyclic and may or may not contain a hetero atom, such as oxygen, in its chain. In other words, the aliphatic group may be composed solely of carbon and hydrogen or may contain a hetero atom.

Examples of the aliphatic diol include alkyldiols and alicyclic diols, such as ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 1,4-cyclohexanediol, 1,4-cyclohexanedimethanol, 2,2,4-trimethyl-1,3-pentanediol, 2-ethyl-1,3-hexanediol, 2-methyl-1,8-octanediol, 1,9-nonanediol, and 1,10-decanediol.

Examples of preferred aliphatic diols are at least one of ethylene glycol, 1,2-propanediol, and 1,3-propanediol. At least one of ethylene glycol and 1,2-propanediol is more preferred. In using two aliphatic glycols in combination, a combination of ethylene glycol and 1,2-propanediol is preferred.

The glycol preferably contains 2 to 10, more preferably 2 to 6, even more preferably 2 to 4, carbon atoms. When two or more glycols are used in combination, a plurality of the glycols preferably have an average number of carbon atoms within the range recited above. The number of carbon atoms of the glycol being in that range, the condensation product achieves not only reduction of light unevenness in application to image display devices but also hardly bleeds out during film formation or film stretching under heat owing to its good compatibility with a cellulose ester.

As previously referred to, it is preferred that both the terminals of the condensation product between the polyhydric alcohol and the polybasic acid be protected with a monohydric alcohol residue or a monocarboxylic acid residue.

The monohydric alcohol residue as a protective group is preferably an optionally substituted C1-C30 monohydric alcohol residue, including those of aliphatic alcohols, such as methanol, ethanol, propanol, isopropyl alcohol, butanol, isobutanol, pentanol, isopentanol, hexanol, isohexanol, cyclohexyl alcohol, octanol, isooctanol, 2-ethylhexyl alcohol, nonyl alcohol, isononyl alcohol, t-nonyl alcohol, decanol, dodecanol, dodecahexanol, dodecaoctanol, allyl alcohol, and oleyl alcohol; and those of substituted alcohols, such as benzyl alcohol and 3-phenylpropanol.

The monocarboxylic acid residue as a protective group is preferably an optionally substituted C1-C30 monocarboxylic acid residue, which may be either aliphatic or aromatic. Examples of preferred aliphatic monocarboxylic acid residues are those of acetic acid, propionic acid, butanoic acid, caprylic acid, caproic acid, decanoic acid, dodecanoic acid, stearic acid, and oleic acid. Examples of usable aromatic monocarboxylic acid residues are those of benzoic acid, p-t-butylbenzoic acid, o-toluoylic acid, m-toluoylic acid, p-toluoylic acid, dimethylbenzoic acid, ethylbenzoic acid, n-propylbenzoic acid, aminobenzoic acid, and acetoxybenzoic acid. These monocarboxylic acids may be used either alone or in combination of two or more thereof.

When the terminating monocarboxylic acid residue contains fewer than 4 carbon atoms, the condensation product has reduced volatility, that is, the loss of the condensation product on heating is minimized to prevent process contamination and reduce the occurrence of film surface defects. From this viewpoint, the monocarboxylic acid used in terminal blocking is preferably an aliphatic monocarboxylic acid, more preferably a C2-C22 aliphatic monocarboxylic acid, even more preferably a C2-C3 aliphatic monocarboxylic acid, most preferably a C2 aliphatic monocarboxylic acid. For example, acetic acid, propionic acid, butanoic acid, or a derivative thereof is preferred. Acetic acid or propionic acid is more preferred. Acetic acid, which provides an acetyl group as a terminal group, is the most preferred. Two or more monocarboxylic acids may be used for terminal blocking.

In the case where the polyhydric alcohol/polybasic acid condensation product has its both terminals unblocked, the condensation product is preferably a polyester polyol.

Examples of preferred polyhydric alcohol/polybasic acid condensation products include poly(ethylene glycol/adipic acid) ester, poly(propylene glycol/adipic acid) ester, poly(1,3-butanediol/adipic acid) ester, poly(propylene glycol/sebacic acid) ester, poly(1,3-butanediol/sebacic acid) ester, poly(1,6-hexanediol/adipic acid) ester, poly(propylene glycol/phthalic acid) ester, poly(1,3-butanediol/phthalic acid) ester, poly(propylene glycol/terephthalic acid) ester, poly(propylene glycol/1,5-naphthalenedicarboxylic acid) ester, poly(propylene glycol/terephthalic acid) ester with both terminals thereof esterified with 2-ethylhexyl alcohol, poly(propylene glycol/adipic acid) ester with both terminals thereof esterified with 2-ethylhexyl alcohol, and acetylated poly(butanediol/adipic acid) ester.

The condensation product of the invention is easily synthesized by (1) melt condensation by (poly)esterification or interesterification between the dibasic acid or an alkyl ester thereof and the glycol or (2) interfacial condensation between an acid chloride of the polybasic acid and the glycol. For the details of the polyhydric alcohol/polybasic acid condensation products, reference may be made to K. Murai (ed.), KASOZAI SONO RIRONTO OHYO, Saiwai Shobo, 1973. Materials useful to prepare the condensation product are described, e.g., in JP 5-155809A, JP 5-155810A, JP 5-197073A, JP 2006-259494A, JP 7-330670A, JP 2006-342227A, and JP 2007-3679A.

Commercially available polyhydric alcohol/polybasic acid condensation products may be used, including a series of Adekacizer (Adekacizer P and PN series) described in DIARY 2007, pp. 55-27; a series of Polylite described in Polymer-related Commodity List (2007) by DIC, p. 25; Polycizers described in DICno Polymer kaishituzai, pp. 2-5 (2004) by DIC; and a series of Plasthall P from CP Hall Co., USA. A benzoyl-functional polyether is commercially available from Velsicol Chemical Corp., Rosemont, Ill., USA under the tradename Benzoflex (e.g., Benzoflex 400, a tradename of polypropylene glycol dibenzoate).

### [I-2] Condensation Product of Polyhydric Ether Alcohol and Polybasic Acid

The term “polyhydric alcohol having an average of 2.01 or more carbon atoms” as used herein includes not only a polyhydric alcohol containing no ether linkage in the molecule thereof but a polyhydric ether alcohol (polyhydric alcohol having an ether linkage in the molecule thereof) having an average of 2.01 or more carbon atoms.

Examples of the dicarboxylic acid to be condensed with the polyhydric ether alcohol include the same C4-C12 aliphatic dicarboxylic acids and C8-C12 aromatic dicarboxylic acids as described with respect to the condensation product between the polyhydric alcohol and the polybasic acid.

The polyhydric ether alcohol is preferably a C2-C12 aliphatic polyhydric ether alcohol, particularly diethylene glycol and dipropylene glycol.

To achieve improvement of stability of retardation in moist heat as contemplated by the invention, it is preferred that at least one of the carbon atoms bonded to the hydroxyl groups of the polyhydric ether alcohol is a secondary or tertiary carbon atom.

The condensation product of the polyhydric ether alcohol with the polybasic acid may be a condensation product between a polyether diol and a dicarboxylic acid. Examples of polyether diols containing a C2-C12 aliphatic glycol include polyethylene ether glycol, polypropylene ether glycol, polytetramethylene glycol, and combinations thereof. Examples of commercially available, typically useful polyether glycols are Carbowax resins, Pluronics resins, and Niax resins. The polyester polyethers that can be used in the invention may be prepared by any polymerization techniques commonly known to those skilled in the art.

The polyhydric ether alcohol/polybasic acid condensation product is exemplified by the compound described in U.S. Pat. No. 4,349,469, which is a condensation product obtained essentially from 1,4-cyclohexanedicarboxylic acid as a dicarboxylic acid component and a polyhydric ether alcohol synthesized from 1,4-cyclohexanedimethanol, polytetramethylene ether glycol, etc. as a polyether component. Further included in useful polyhydric ether alcohol/polybasic acid condensation products are commercially available resins, such as Hytrel copolyesters from Du Pont and Galflex polymers from GAF. The materials described in JP 5-197073A may be used to prepare these resins. Adekacizer RS series, which are polyether ester plasticizers available from Adeka, and alkyl-functionalized polyalkylene oxides Pycal (e.g., Pycal 94, polyethylene oxide phenyl ester), which are polyether ester plasticizers available from ICI Chemicals, Wilmington, Del., are also useful.

### [I-3] Condensation Product of Polyhydric Alcohol/Polybasic Acid Condensation Product and Isocyanate Compound

The condensation product that can be used in the invention may be a condensation product obtained from a polyhydric alcohol having an average of 2.01 or more carbon atoms, a polybasic acid having an average of 4.10 or more carbon atoms, and an isocyanate compound. This condensation product is prepared by the condensation reaction between a polyhydric alcohol/polybasic acid condensation product and an isocyanate compound. The condensation product to be condensed with an isocyanate compound may be the above mentioned non-terminal-blocked polyhydric alcohol/polybasic acid condensation product as obtained. The above described preferred materials for use in the preparation of the polyhydric alcohol/polybasic acid condensation product are preferably used here.

Examples of the isocyanate compound include, but are not limited to, polymethylene diisocyanates represented by OCN(CH₂)ₚNCO (p=2 to 8), such as ethylene diisocyanate, trimethylene diisocyanate, tetramethylene diisocyanate, and hexamethylene diisocyanate; aromatic diisocyanates, such as p-phenylene diisocyanate, tolylene diisocyanate, p,p′-diphenylmethane diisocyanate, and 1,5-naphthylene diisocyanate; and m-xylylene diisocyanate. Preferred of them are tolylene diisocyanate, m-xylylene diisocyanate, and tetramethylene diisocyanate. Upon condensing the isocyanate component with the polyhydric alcohol/polybasic acid condensation product, a polyurethane structure forms.

The polyhydric alcohol/polybasic acid condensation product/isocyanate condensation product is easily synthesized in a usual manner by mixing and heating the polyester diols and a diisocyanate while stirring. The starting materials may be chosen from those described in JP 5-197073A, JP 2001-122979A, JP 2004-175971A, and JP 2004-175972A.

Of the aforementioned polyhydric alcohol/polybasic acid condensation products, preferred for use in the invention are those prepared from materials including no isocyanate compound, and more preferred are those prepared from materials including neither an isocyanate compound nor a polyhydric ether alcohol.

The optical film of the invention contains more than 30% by mass of the condensation product based on the cellulose ester. The content of the condensation product relative to the cellulose ester is preferably not more than 150%, more preferably not more than 100%, even more preferably from 31% to 80%, even still more preferably from 35% to 80%, yet more preferably from 40% to 60%, and most preferably from 40% to 55%, by mass. With the condensation product content more than 30%, the light unevenness problem is alleviated. With the condensation product content of 150% or less, the bleeding can be prevented.

When two or more condensation products are used in combination, the above ranges apply to the total content of them.

### [II] Additives

With respect to the retardation stability in moist heat, changes of retardation include a change observed when a film is maintained under a moist heat condition and a change observed when a film as assembled into a polarizing plate is maintained under a moist heat condition. The former change of retardation can be reduced by using the above described condensation product and/or controlling the dimensional change as hereinafter described. The latter change of retardation can be reduced by using the above described condensation product and/or adding a compound that improves the moist heat stability of retardation.

The compound that improves the moist heat stability of retardation is preferably a compound having basicity, which may be either organic or inorganic, or an organic compound and an inorganic compound may be used in combination. A weakly basic compound is more preferred. Examples of inorganic compounds having basicity, i.e., inorganic bases include sodium hydroxide, potassium hydroxide, sodium carbonate, sodium hydrogencarbonate, potassium carbonate, and potassium hydrogencarbonate. Examples of organic compounds having basicity, i.e., organic bases include those containing a basic functional group in the molecule. Examples of the basic functional group are primary amino, secondary amino, tertiary amino, quaternary ammonium, N-containing heterocyclic groups, e.g., pyridyl, pyrimidinyl, and pyrazinyl, guanidino, imino, imidazolyl, indole, and purine.

It is preferred for the optical film of the invention to contain a compound having an amino group as a compound that improves the moist heart stability of the retardation. The compound having an amino group that can be preferably used in the invention is not particularly limited but is preferably a compound having a triazine nucleus and an amino substituent bonded thereto, particularly a compound represented by formula (1) or (2):

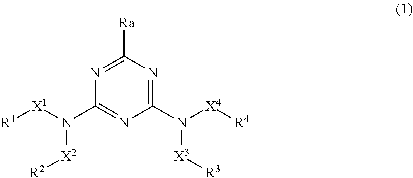

wherein Ra represents an optionally substituted alkyl group, an optionally substituted alkenyl group, an optionally substituted alkynyl group, an optionally substituted heterocyclic group, or an optionally substituted aryl group; X¹, X², X³, and X⁴ each independently represent a single bond or a divalent linking group; R¹, R², R³, and R⁴ each independently represent hydrogen, an optionally substituted alkyl group, an optionally substituted alkenyl group, an optionally substituted alkynyl group, an optionally substituted aryl group, an optionally substituted acyl group, or an optionally substituted heterocyclic group.

Ra is preferably alkyl or aryl, more preferably aryl.

The alkyl as Ra preferably contains 1 to 20 carbon atoms, more preferably 3 to 15 carbon atoms, even more preferably 6 to 12 carbon atoms. The alkenyl or alkenyl as Ra preferably contains 2 to 20 carbon atoms, more preferably 2 to 15 carbon atoms, even more preferably 2 to 12 carbon atoms. The aryl as Ra preferably contains 6 to 30 carbon atoms, more preferably 6 to 20 carbon atoms. Even more preferably, the aryl is phenyl. The heterocyclic group as Ra is preferably an N-containing aromatic heterocyclic group, particularly pyridyl.

The substituent that may be possessed by the alkyl, alkenyl, alkynyl, aryl, or heterocyclic group as Ra include alkyl, preferably C1-C20, more preferably C1-C12, even more preferably C1-C8 alkyl, such as methyl, ethyl, isopropyl, t-butyl, n-octyl, n-decyl, n-hexadecyl, cyclopropyl, cyclopentyl, and cyclohexyl; alkenyl, preferably C2-C20, more preferably C2-C12, even more preferably C2-C8 alkenyl, such as vinyl, allyl, 2-butenyl, and 3-pentenyl; alkynyl, preferably C2-C20, more preferably C2-C12, even more preferably C2-C8 alkynyl, such as propargyl and 3-pentynyl; aryl, preferably C6-C30, more preferably C6-C20, even more preferably C6-C12 aryl, such as phenyl, biphenyl, and naphthyl; amino, preferably C0-C20, more preferably C0-C10, even more preferably C0-C6 amino, such as amino, methylamino, dimethylamino, diethylamino, and dibenzylamino; alkoxy, preferably C1-C20, more preferably C1-C12, even more preferably C1-C8 alkoxy, such as methoxy, ethoxy, and butoxy; aryloxy, preferably C6-C20, more preferably C6-C16, even more preferably C6-C12 aryloxy, such as phenyloxy and 2-naphthyloxy; acyl, preferably C1-C20, more preferably C1-C16, even more preferably C1-C12 acyl, such as acetyl, benzoyl, formyl, and pivaloyl; alkoxycarbonyl, preferably C2-C20, more preferably C2-C16, even more preferably C2-C12 alkoxycarbonyl, such as methoxycarbonyl and ethoxycarbonyl; aryloxycarbonyl, preferably C7-C20, more preferably C7-C16, even more preferably C7-C10 aryloxycarbonyl, such as phenyloxycarbonyl; acyloxy, preferably C2-C20, more preferably C2-C16, even more preferably C2-C10 acyloxy, such as acetoxy and benzoyloxy; acylamino, preferably C2-C20, more preferably C2-C16, even more preferably C2-C10 acylamino, such as acetylamino and benzoylamino; alkoxycarbonylamino, preferably C2-C20, more preferably C2-C16, even more preferably C2-C12 alkoxycarbonylamino, such as methoxycarbonylamino; aryloxycarbonylamino, preferably C7-C20, more preferably C7-C16, even more preferably C7-C12 aryloxycarbonylamino, such as phenyloxycarbonylamino; sulfonylamino, preferably C1-C20, more preferably C1-C16, even more preferably C1-C12 sulfonylamino, such as methanesulfonylamino and benzenesulfonylamino; sulfamoyl, preferably C0-C20, more preferably C0-C16, even more preferably C0-C12 sulfamoyl, such as sulfamoyl, methylsulfamoyl, dimethylsulfamoyl, and phenylsulfamoyl; carbamoyl, preferably C1-C20, more preferably C1-C16, even more preferably C1-C12 carbamoyl, such as carbamoyl, methylcarbamoyl, diethylcarbamoyl, and phenylcarbamoyl; alkylthio, preferably C1-C20, more preferably C1-C16, even more preferably C1-C12 alkyl thio, such as methylthio and ethylthio; arylthio, preferably C6-C20, more preferably C6-C16, even more preferably C6-C12 arylthio, such as phenylthio; sulfonyl, preferably C1-C20, more preferably C1-C16, even more preferably C1-C12 sulfonyl, such as mesyl and tosyl; sulfinyl, preferably C1-C20, more preferably C1-C16, even more preferably C1-C12 sulfinyl, such as methanesulfinyl and benzenesulfinyl; ureido, preferably C1-C20, more preferably C1-C16, even more preferably C1-C12 ureido, such as ureido, methylureido, and phenylureido; phosphoramido, preferably C1-C20, more preferably C1-C16, even more preferably β1-012 phosphoramido, such as diethylphosphoramido and phenylphosphoramido; hydroxyl; mercapto; halogen (e.g., fluorine, chlorine, bromine, or iodine); cyano; sulfo; carboxyl; nitro; hydroxamic acid; sulfino; hydrazino; imino; heterocyclic, preferably C1-C30, more preferably C1-C12 heterocyclic, having, e.g., nitrogen, oxygen, or sulfur as a hetero atom, such as imidazolyl, pyridyl, quinolyl, furyl, piperidyl, morpholino, benzoxazolyl, benzimidazolyl, and benzothiazolyl; and silyl, preferably C3-C40, more preferably C3-C30, even more preferably C3-C24 silyl, such as trimethylsilyl and triphenylsilyl. These substituents may further have a substituent. Two or more substituents, if any, may be the same or different and, if possible, may be connected together to form a ring.

X¹ through X⁴, which each represent a single bond or a divalent linking group, may be the same or different and are each preferably a single bond. The linking group is preferably selected from the following group of linking groups (L).

### Group of Linking Groups (L):

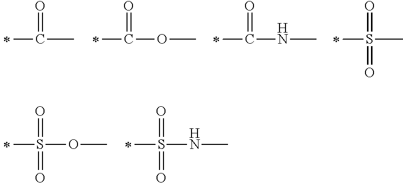

wherein the asterisk * indicates the position of attachment to the nitrogen atom substituting the 1,3,5-triazine ring.

The alkyl as R¹ to R⁴ preferably contains 1 to 12 carbon atoms, more preferably 1 to 6 carbon atoms, even more preferably 1 to 4 carbon atoms. The alkenyl or alkenyl as R¹ to R⁴ preferably contains 2 to 12 carbon atoms, more preferably 2 to 6 carbon atoms, even more preferably 2 to 4 carbon atoms. The aryl as R¹ to R⁴ preferably contains 6 to 18 carbon atoms, more preferably 6 to 12 carbon atoms, even more preferably 6 carbon atoms.

R¹ through R⁴ are each preferably hydrogen, alkyl, or aryl, more preferably hydrogen.

The alkyl, alkenyl, alkynyl, aryl, acyl, or heterocyclic group as R¹ to R⁴ may have a substituent selected from those described with reference to the substituent in Ra.

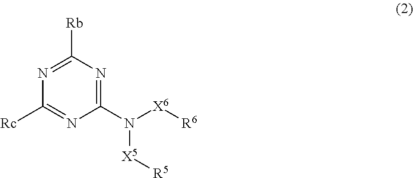

wherein Rb and Rc each independently represent an optionally substituted alkyl group, an optionally substituted alkenyl group, an optionally substituted alkynyl group, an optionally substituted heterocyclic group, or an optionally substituted aryl group; X⁵ and X⁶ each independently represent a single bond or a divalent linking group; and R⁵ and R⁶ each independently represent hydrogen, an optionally substituted alkyl group, an optionally substituted alkenyl group, an optionally substituted alkynyl group, an optionally substituted aryl group, an optionally substituted acyl group, or an optionally substituted heterocyclic group.

Examples of the alkyl, alkenyl, alkynyl, heterocyclic, and aryl as Rb and Rc are the same as those described for Ra. Rb and Rc are each preferably alkyl or aryl.

Examples and preferred ranges of X⁵ and X⁶ are the same as those described for X¹ through X⁶.

Examples and preferred ranges of R⁵ and R⁶ are the same as those described for R¹ through R⁴.

The amount of the compound having an amino group to be added is preferably, but not limited to, 0.001% to 20%, more preferably 0.01% to 10%, even more preferably 0.05% to 5%, most preferably 0.1% to 3%, by mass relative to the cellulose ester.

Examples of the compounds having an amino group represented by formula (1) or (2) are shown below.

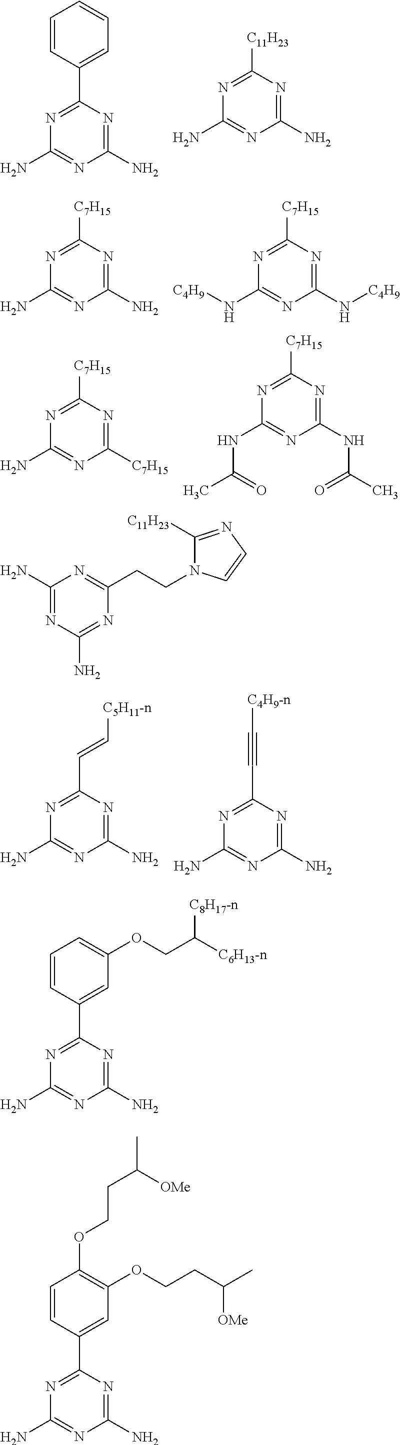

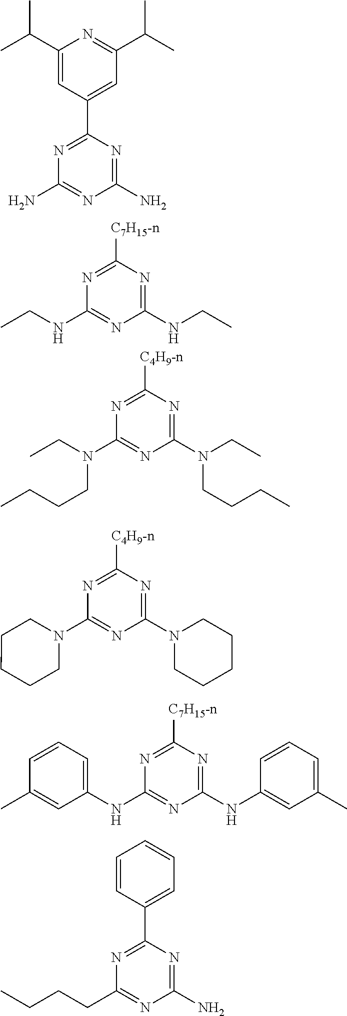

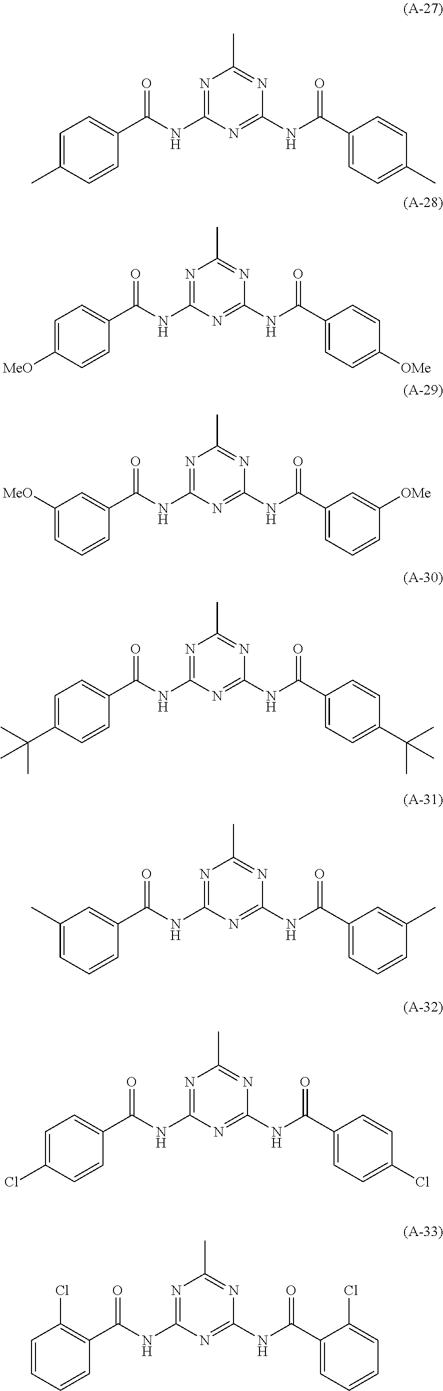

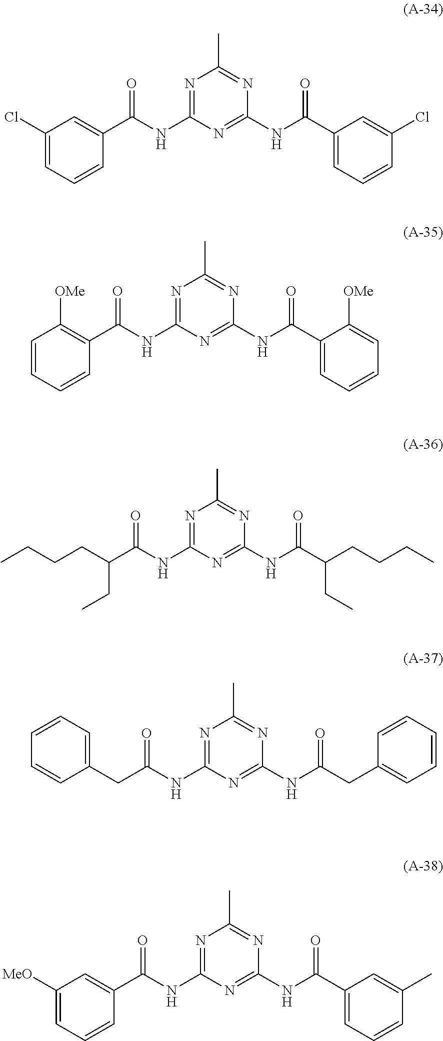

Also included in examples of the compound having an amino group that can be preferably used in the invention is a compound having a pyridine or pyrimidine nucleus and an amino group bonded thereto. Such a compound is exemplified by a compound represented by formula (3):

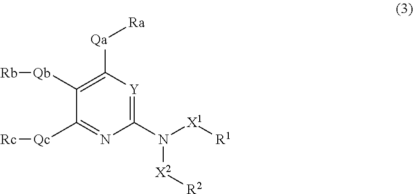

wherein Y represents methine or nitrogen; Qa, Qb, and Qc each independently represent a single bond or a divalent linking group; Ra, Rb, and Rc each independently represent hydrogen, optionally substituted alkyl, optionally substituted alkenyl, optionally substituted alkynyl, optionally substituted aryl, cyano, halogen, optionally substituted heterocyclic, or —N(Rd)(Rd′); Rd and Rd′ each independently represent hydrogen or a substituent; Rd and Rd′ may be taken together to form a ring; Ra and Rb may be taken together to form a ring; X¹ represents a single bond or a divalent linking group selected from the group of linking groups (L′) shown below; X² represents a single bond or a divalent linking group; R¹ and R² each independently represent hydrogen, optionally substituted alkyl, optionally substituted alkenyl, optionally substituted alkynyl, optionally substituted aryl, or optionally substituted heterocyclic group; and R¹ and R² may be taken together to form a ring.

### Group of Linking Groups (L′):

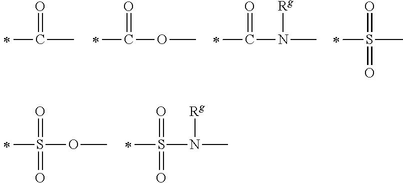

wherein the asterisk * indicates the position of attachment to the nitrogen atom substituting the N-containing aromatic ring; and Rg represents optionally substituted alkyl, optionally substituted alkenyl, optionally substituted alkynyl, optionally substituted aryl, or optionally substituted heterocyclic group.

In formula (3), Y is preferably hydrogen from the viewpoint of enhancing hydrogen bonding.

The divalent linking group as Qa, Qb, or Qc is preferably an oxygen atom, a sulfur atom, or —N(Rf)-, wherein Rf is hydrogen or alkyl. The alkyl as Rf is preferably C1-C10 alkyl, more preferably C1-C5 alkyl.

Qa is preferably a single bond, oxygen, or —NH—, more preferably a single bond or oxygen. Qb is preferably a single bond. Qc is preferably a single bond.

The alkyl as Ra, Rb, or Rc is preferably C1-C12, more preferably C1-C8, even more preferably C1-C6, most preferably C1-C4 alkyl. The alkenyl as Ra, Rb, or Rc is preferably C2-C12, more preferably C2-C6, even more preferably C2-C4 alkenyl. The alkynyl as Ra, Rb, or Rc is preferably C2-C12, more preferably C2-C6, even more preferably C2-C4 alkynyl. The aryl as Ra, Rb, or Rc is preferably C6-C18, more preferably C6-C12, even more preferably C6 (i.e., phenyl) aryl. The heterocyclic group as Ra, Rb, or Rc is exemplified by morpholinyl. Rd and Rd′ in —N(Rd) (Rd′)- as Ra, Rb, or Rc are each preferably hydrogen.

Ra, Rb, and Rc may each have a substituent. Examples of the substituent are the same as those listed for Ra in formula (1).

The ring formed by Ra and Rb taken together is preferably an N-containing aromatic ring, particularly an imidazole ring.

Ra is preferably hydrogen, alkyl, or aryl, more preferably hydrogen or alkyl. Rb is preferably hydrogen. Rc is preferably —N(Rd) (Rd′).

Examples of the substituents as Rd or Rd′ are the same as those described with respect to the substituent that may be possessed by Ra, Rb, and Rc. The substituent as Rd or Rd′ may further have a substituent, suitable examples of which are the same as those described as for the substituent that may be possessed by Ra, Rb, or Rc.

X¹ is preferably any one of the following three linking groups, more preferably carbonyl.

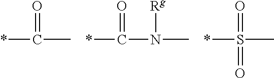

Examples and preferred ranges of the linking group as X² are the same as those described with respect to Qa, Qb, and Qc.

X² is preferably a single bond.

Examples and preferred ranges of the alkyl, alkenyl, alkynyl, aryl, or heterocyclic group as R¹ and R² are the same as those described with respect to Ra, Rb, and Rc. Examples of the substituent R¹ and R² may have are also the same as those described with respect to the substituent Ra, Rb, and Rc may have.

R¹ is preferably optionally substituted aryl. The substituent the aryl as R¹ may have is preferably alkyl, alkoxy, cyano, nitro, halogen, optionally substituted carbamoyl, or optionally substituted sulfamoyl, more preferably C1-C8 alkyl, C1-C8 alkoxy, halogen, optionally substituted carbamoyl, or optionally substituted sulfamoyl. The substituent that the carbamoyl or sulfamoyl may have is preferably alkyl.

R² is preferably hydrogen.

The compound of formula (3) is preferably a compound represented by formula (4):

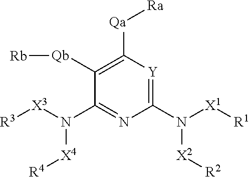

wherein Y, Qa, Qb, Ra, Rb, X¹, X², R¹, and R² are as defined above for formula (3); X³ represents a single bond or a divalent linking group selected from the group of linking groups (L′); X⁴ represents a single bond or a divalent linking group; R³ and R⁴ each independently represent hydrogen, optionally substituted alkyl, optionally substituted alkenyl, optionally substituted alkynyl, optionally substituted aryl, or optionally substituted heterocyclic group; and R³ and R⁴ may be taken together to form a ring.

Examples and preferred ranges of Y, Qa, Qb, Ra, Rb, X¹, X², R¹, and R² in formula (4) are the same as those of as Y, Qa, Qb, Ra, Rb, X¹, X², R¹, and R², respectively, in formula (3).

Examples and preferred ranges of X³ are the same as those for X¹ in formula (3).

Examples and preferred ranges of X⁴ are the same as those for X² in formula (1).

Examples and preferred ranges of R³ and R⁴ are the same as those for R¹ and R² in formula (3).

The compound of formula (4) is preferably a compound represented by formula (5):

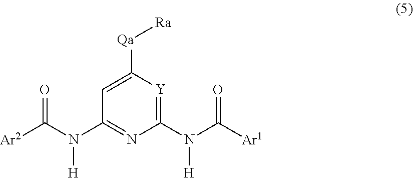

wherein Y, Qa, and Ra have the same meaning as Y, Qa, and Ra, respectively, in formula (4); and Ar¹ and Ar² each independently represent optionally substituted aryl.

Examples and preferred ranges of Y, Qa, and Ra in formula (5) are the same as those in formula (4).

Examples and preferred ranges of the optionally substituted aryl as Ar¹ and Ar² are the same as those described with respect to R¹ in formula (3).

The compound of formula (5) is preferably a compound represented by formula (6):

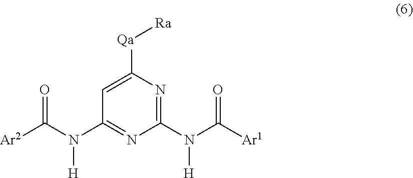

wherein Qa, Ra, Ar¹, and Ar² have the same meaning as Qa, Ra, Ar¹, and Ar², respectively, in formula (5).

Examples and preferred ranges of Qa, Ra, Ar¹, and Ar² are the same as those for formula (5).

The compound of formula (6) is preferably a compound represented by formula (7):

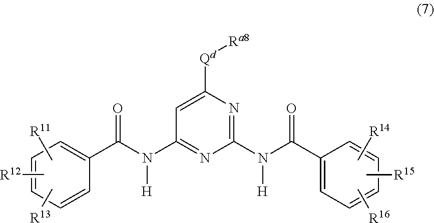

wherein Q^{d} represents a single bond, oxygen, or —NH—; R^{a8} represents C1-C8 alkyl; and R¹¹, R¹², R¹³, R¹⁴, R¹⁵, and R¹⁶ each independently represent hydrogen, halogen, optionally substituted carbamoyl, optionally substituted sulfamoyl, C1-C8 alkyl, or C1-C8 alkoxy.

Q^{d} is preferably a single bond or oxygen.

R¹¹ through R¹⁶ are each preferably hydrogen, optionally substituted carbamoyl, optionally substituted sulfamoyl, C1-C8 alkyl, or C1-C8 alkoxy, more preferably hydrogen or C1-C8 alkyl.

Examples of the compound of formula (3) which are preferably used in the invention are shown below.

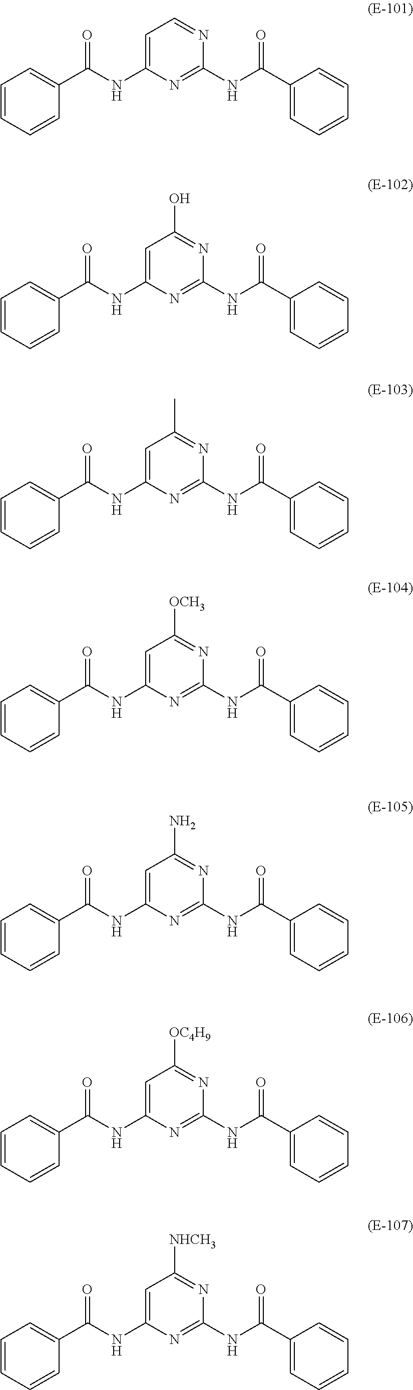

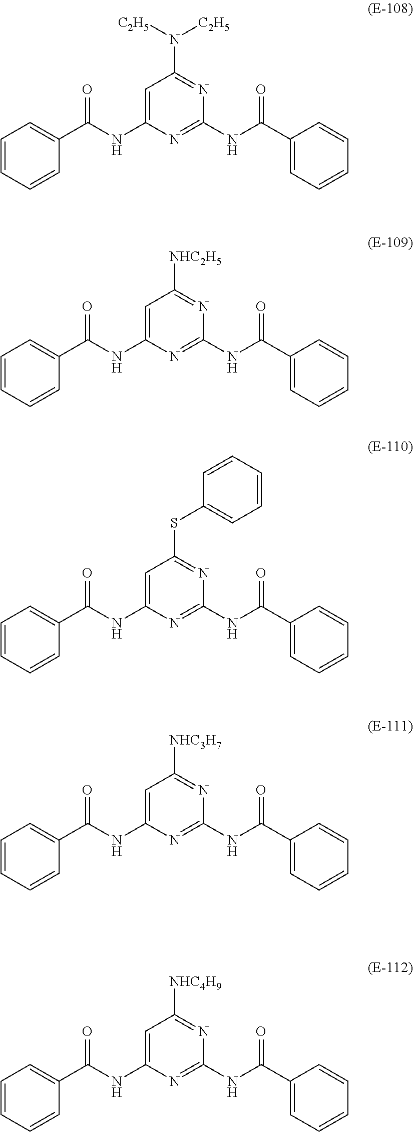

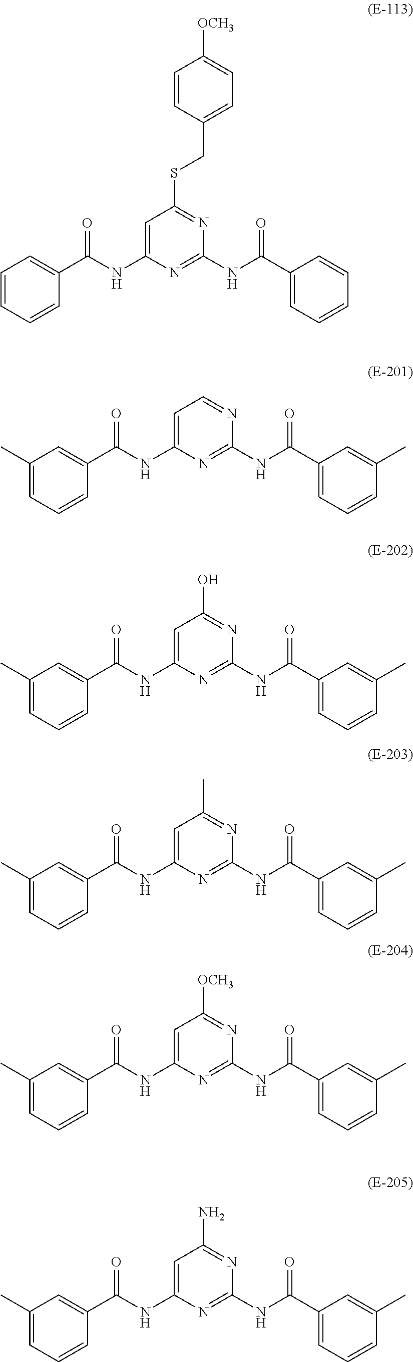

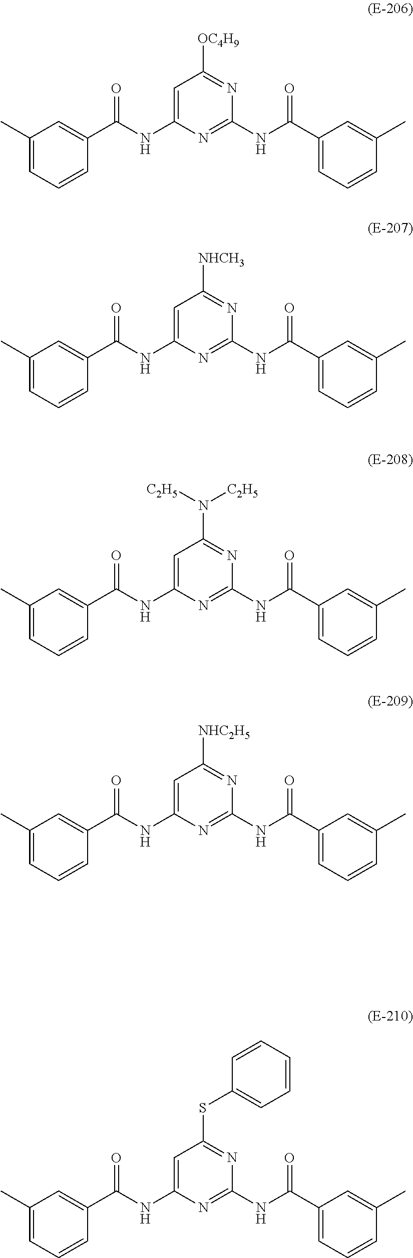

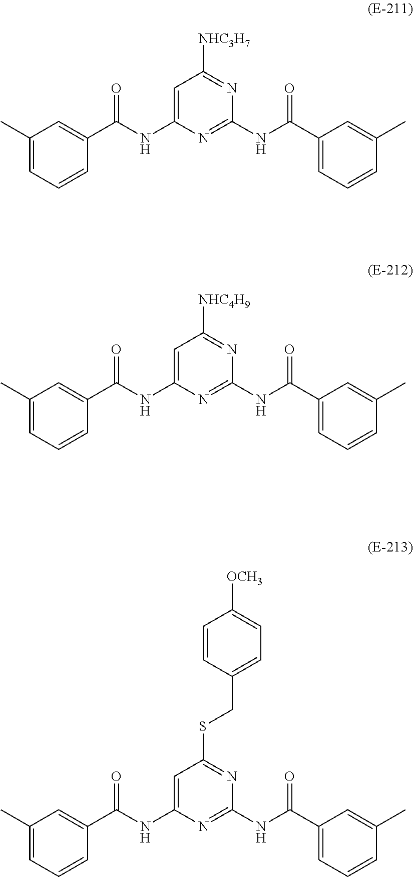

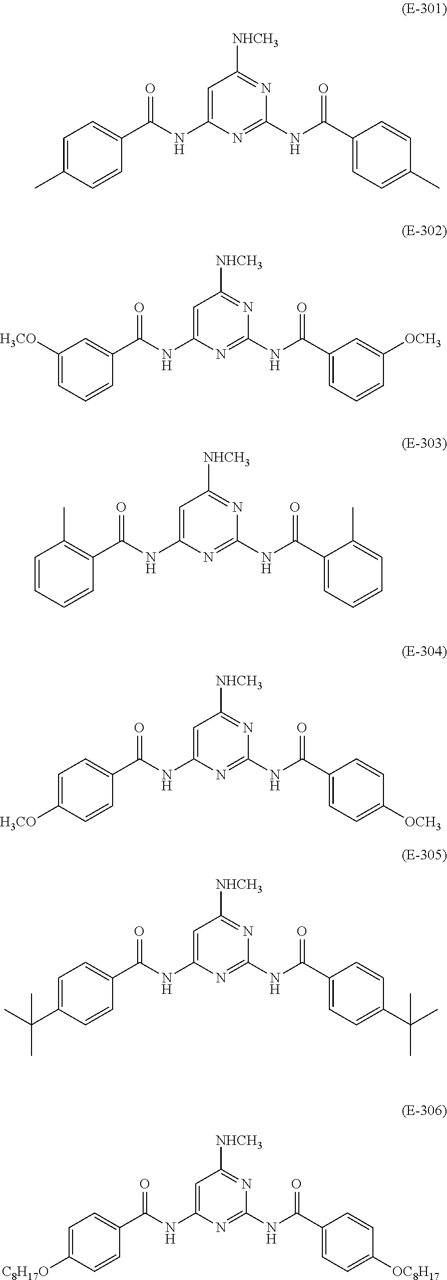

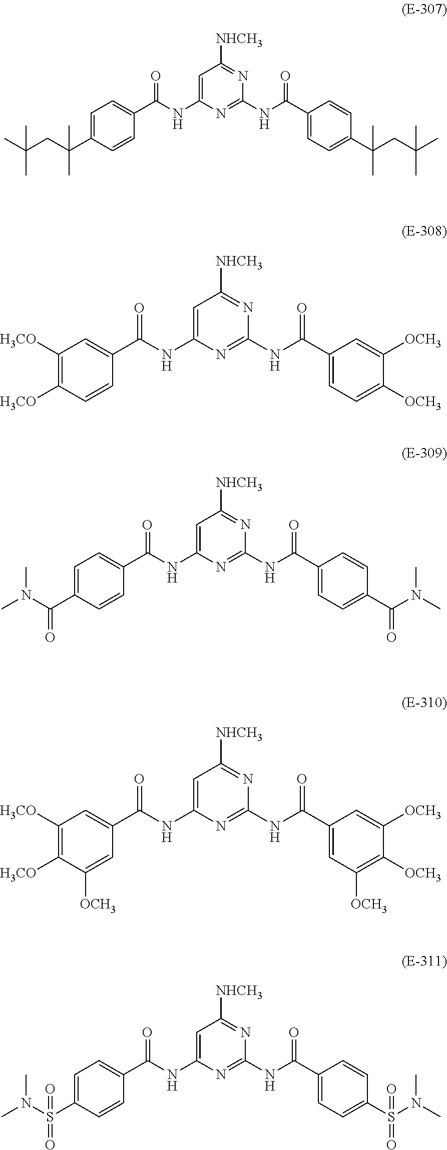

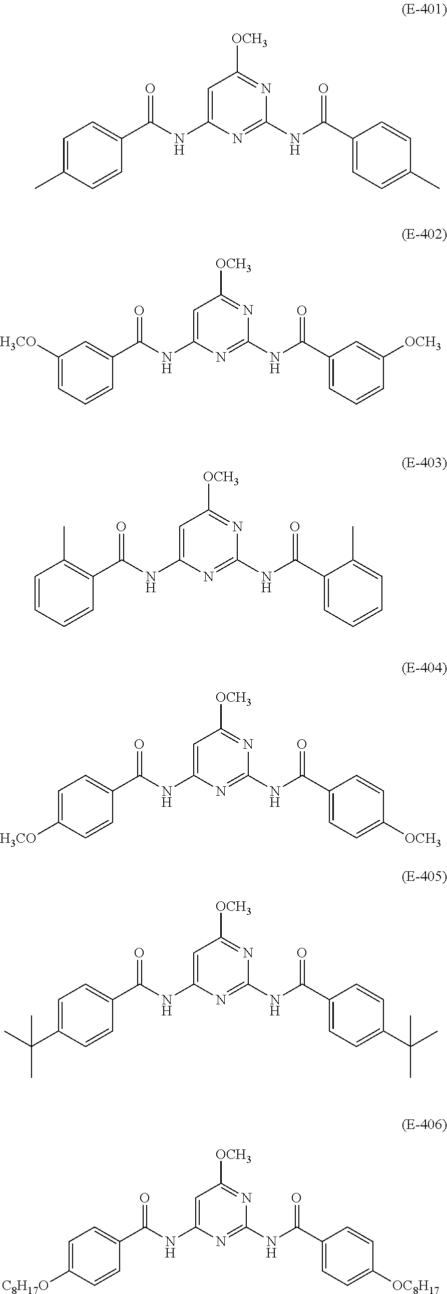

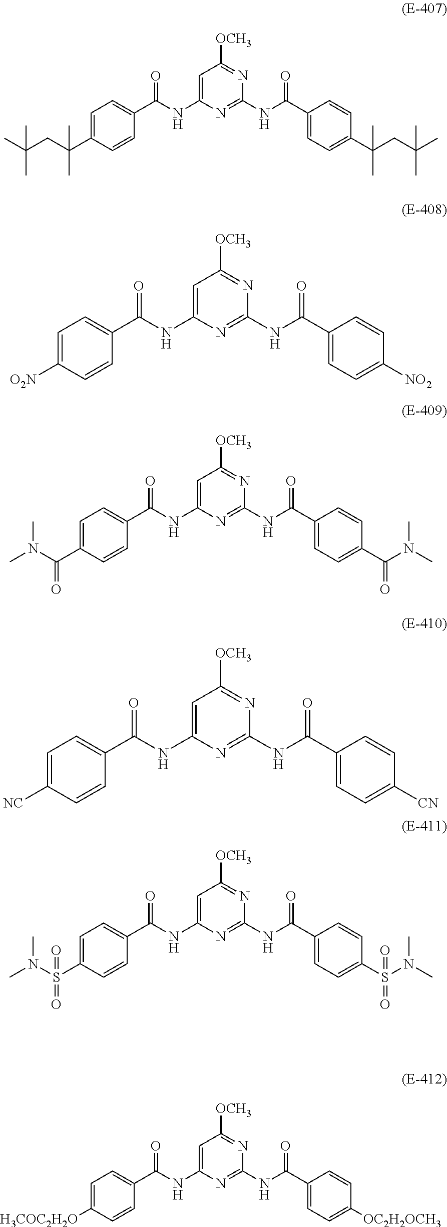

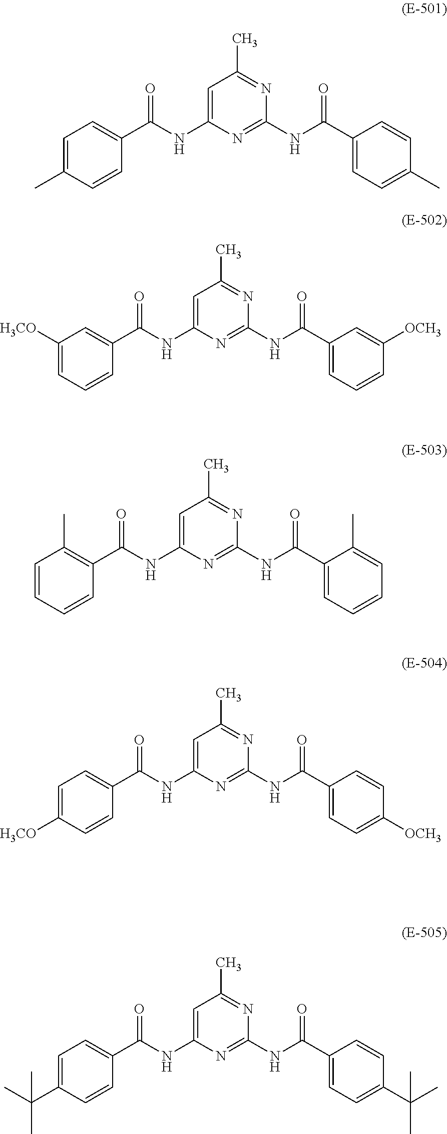

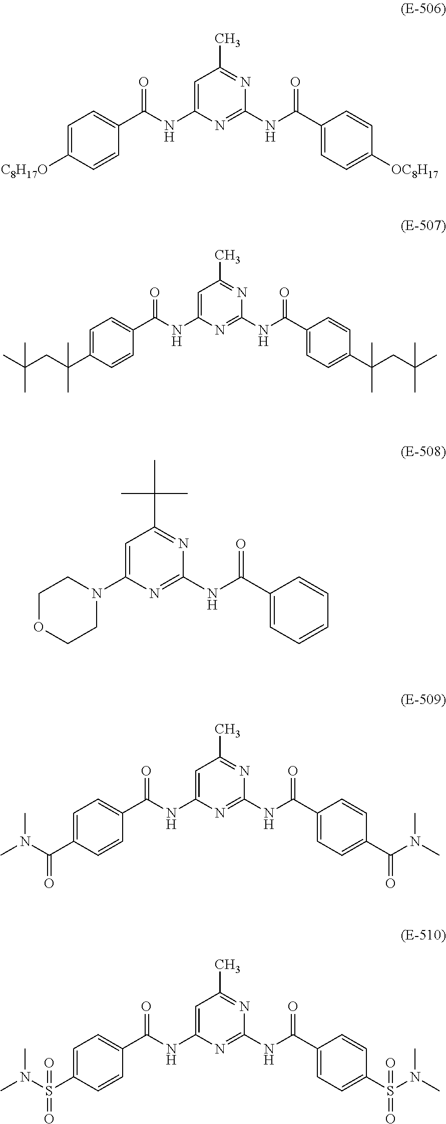

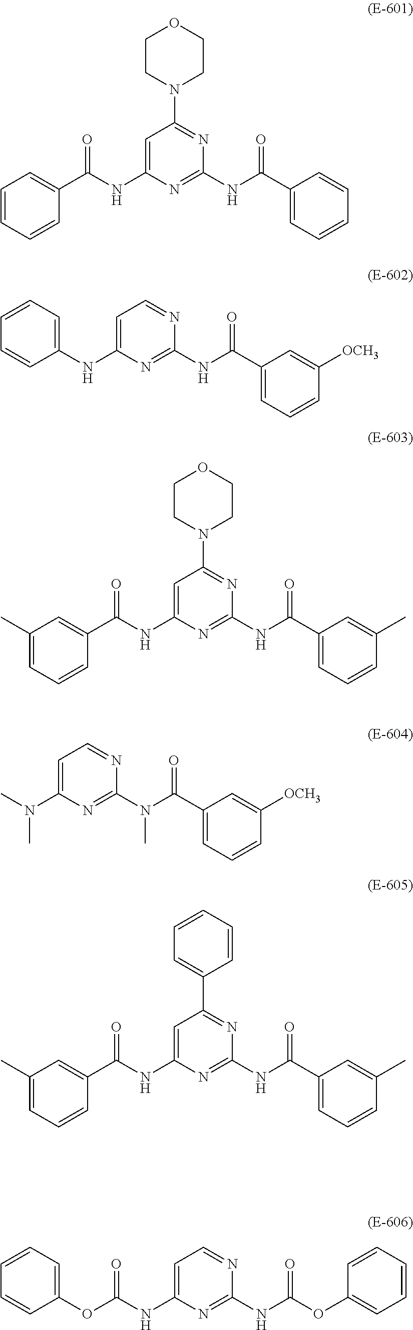

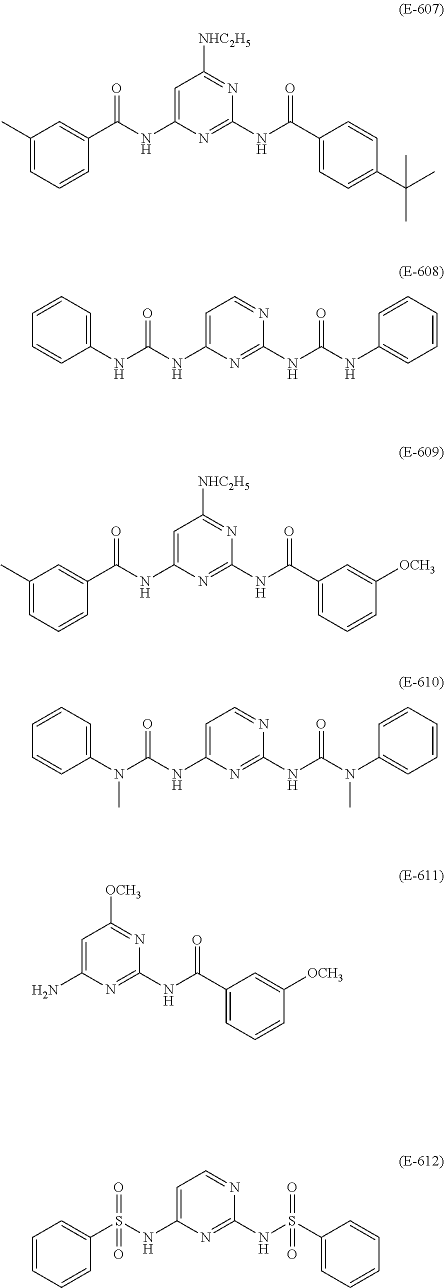

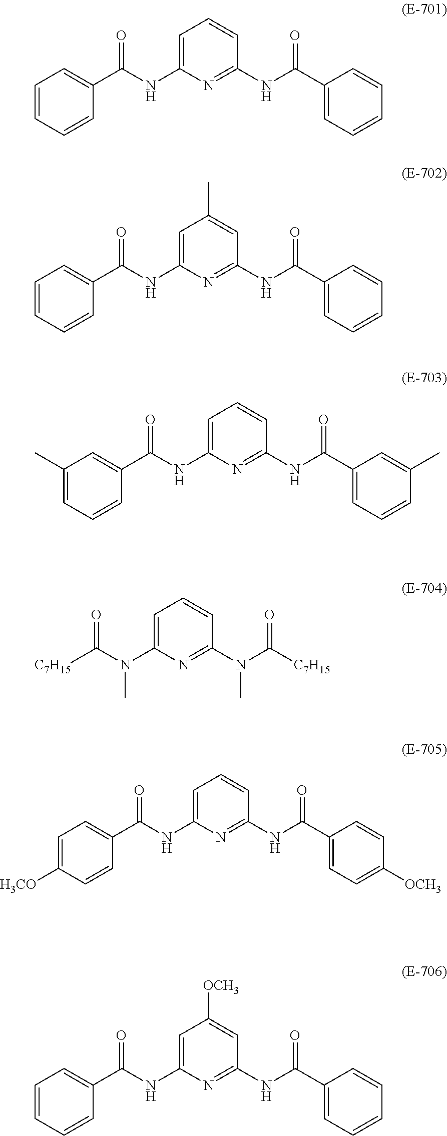

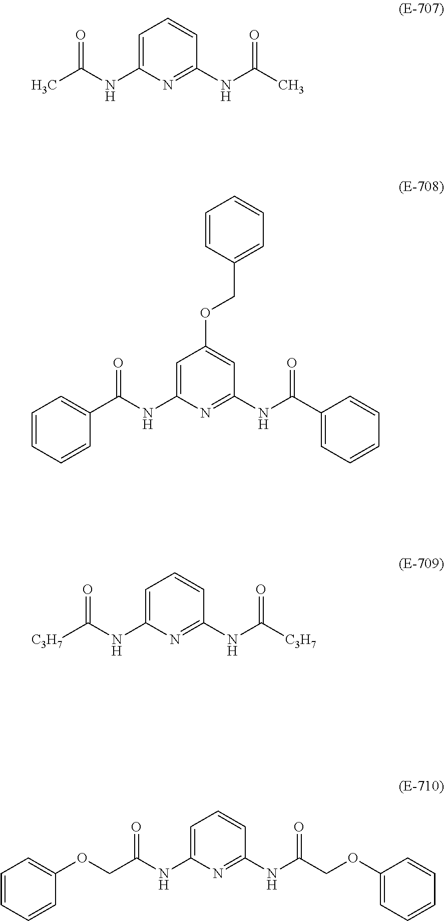

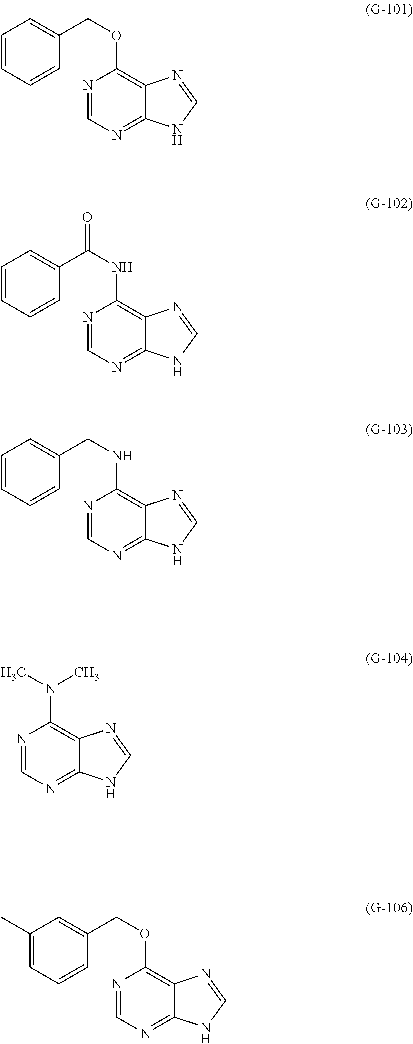

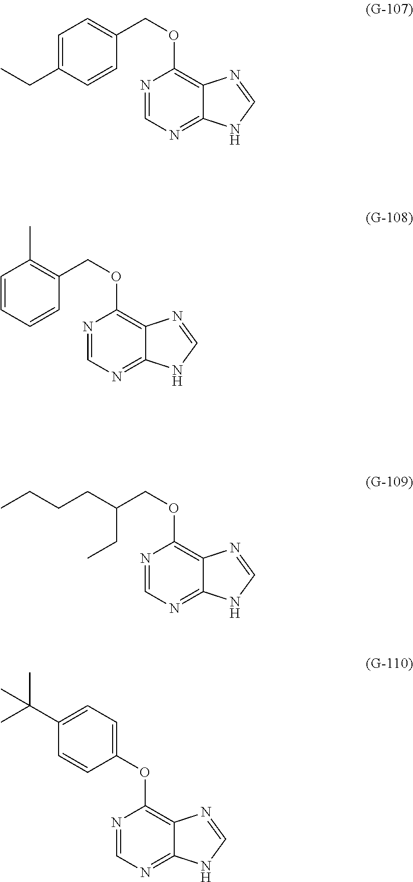

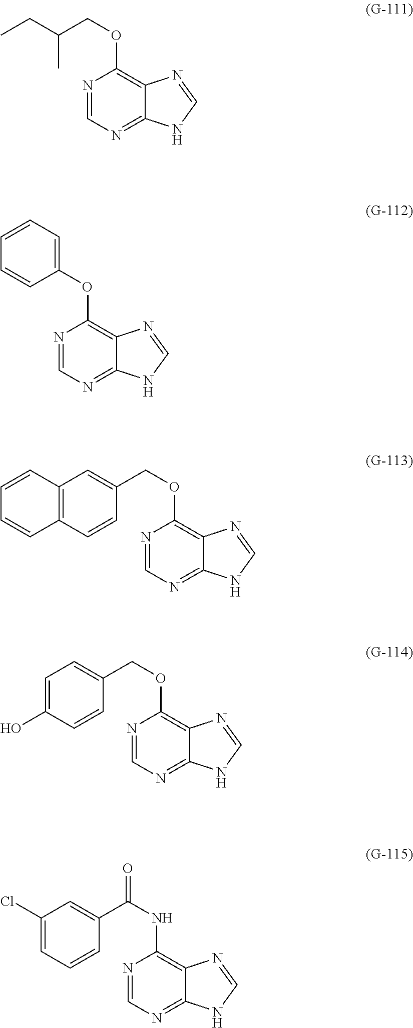

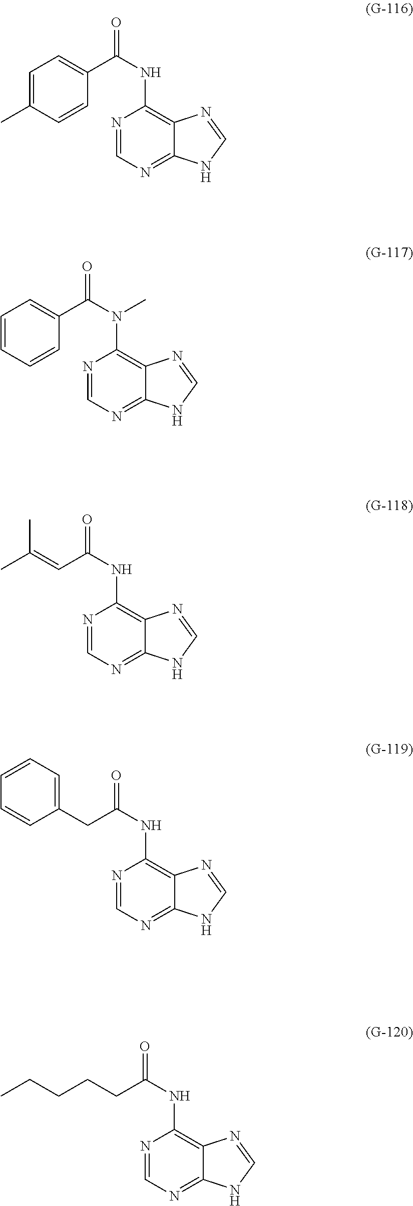

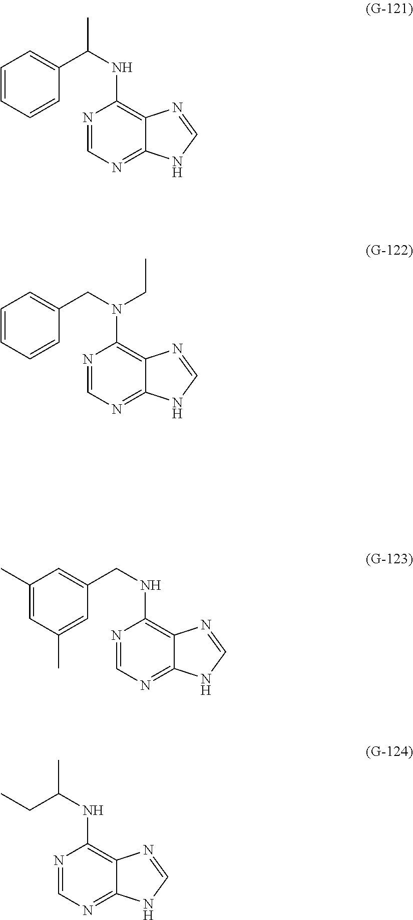

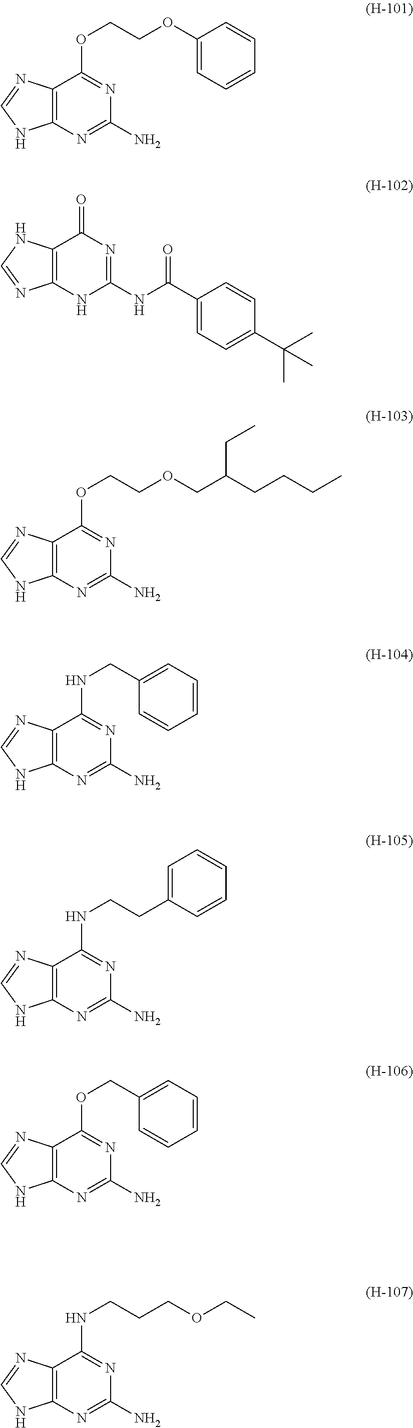

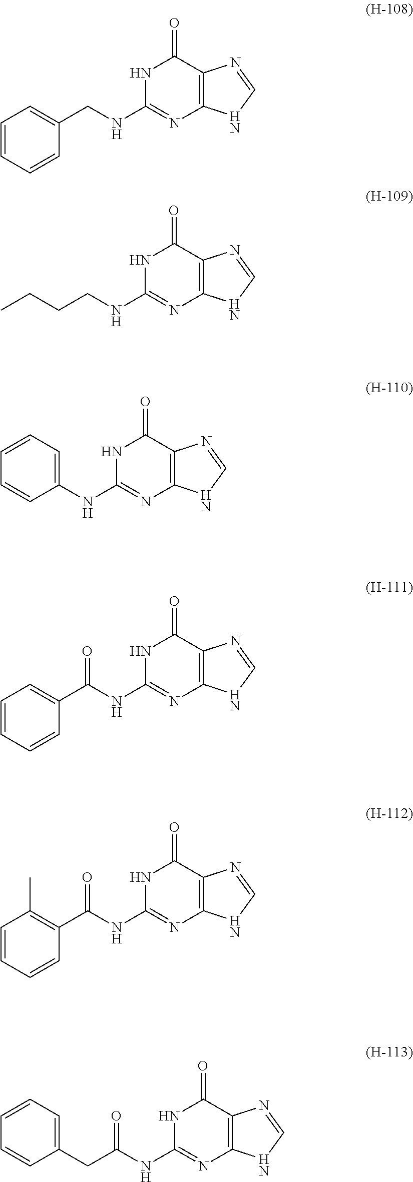

Also included in examples of the compound having an amino group that can be preferably used in the invention is a compound represented by formula (8):

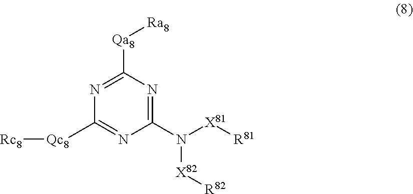

wherein Qa₈ and Qc₈ each independently represent a single bond or a divalent linking group; Ra₈ and Rc₈ each independently represent hydrogen, optionally substituted alkyl, optionally substituted alkenyl, optionally substituted alkynyl, optionally substituted aryl, cyano, halogen, optionally substituted heterocyclic, or —N(Rd) (Rd′) group; Rd and Rd′ each independently represent hydrogen or a substituent; Rd and Rd′ may be taken together to form a ring; X⁸¹ represents a single bond or a divalent linking group selected from the group of linking groups (L′); X⁸² represents a single bond or a divalent linking group; R⁸¹ and R⁸² each independently represent hydrogen, optionally substituted alkyl, optionally substituted alkenyl, optionally substituted alkynyl, optionally substituted aryl, or optionally substituted heterocyclic group; and R⁸¹ and R⁸² may be taken together to form a ring.

Examples of Qa₈ and Qc₈ are the same as those for Qa in formula (3). Examples of Ra₈ and Rc₈ are the same as those for Ra in formula (3). Preferred ranges of X⁸¹, X⁸², R⁸¹, and R⁸² are the same as those described with respect to X¹, X², R¹, R², respectively, in formula (3).

Also included in examples of the compound having an amino group that can be preferably used in the invention is a compound represented by formula (9):

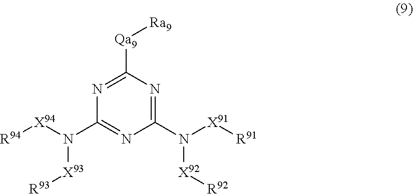

wherein Qa₉ represents a single bond or a divalent linking group; Ra₉ represents hydrogen, optionally substituted alkyl, optionally substituted alkenyl, optionally substituted alkynyl, optionally substituted aryl, cyano, halogen, optionally substituted heterocyclic, or —N(Rd)(Rd′) group; Rd and Rd′ each independently represent hydrogen or a substituent; Rd and Rd′ may be taken together to form a ring; X⁹¹ represents a single bond or a divalent linking group selected from the group of linking groups (L′); X⁹², X⁹³, and X⁹⁴ each independently represent a single bond or a divalent linking group; R⁹¹, R⁹², R⁹³, and R⁹⁴ each independently represent hydrogen, optionally substituted alkyl, optionally substituted alkenyl, optionally substituted alkynyl, optionally substituted aryl, or optionally substituted heterocyclic group; and R⁹¹ and R⁹², and R⁹³ and R⁹⁴ may each be taken together to form a ring.

Examples of Qa₉ and Ra₉ are the same as those for Qa and Ra, respectively, in formula (3). A preferred range of X⁹¹ is the same as that of X¹ in formula (3). Preferred ranges of X⁹² through X⁹⁴ are the same as those for X² in formula (3). A preferred range of R⁹¹ is the same as that for R¹ in formula (3). Preferred ranges of R⁹² through R⁹⁴ are the same as those for R² in formula (3).

Examples of the compounds represented by formula (8) or (9) include, but are not limited to, the following compounds.

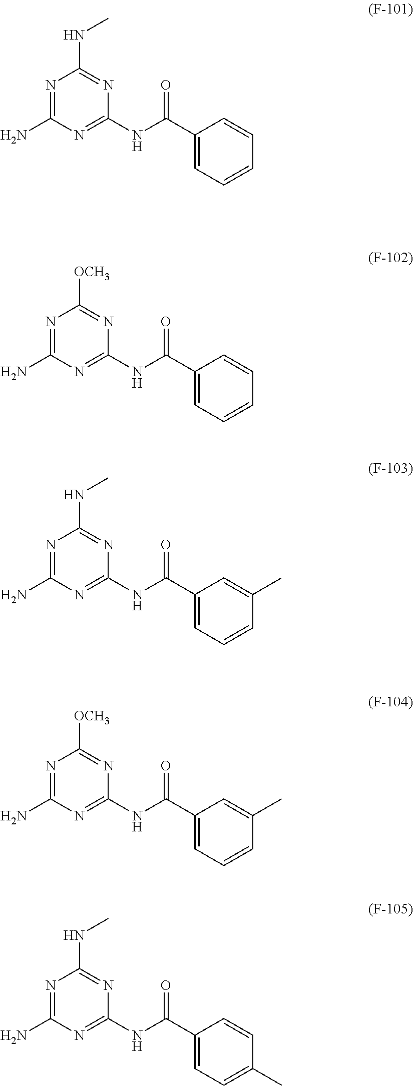

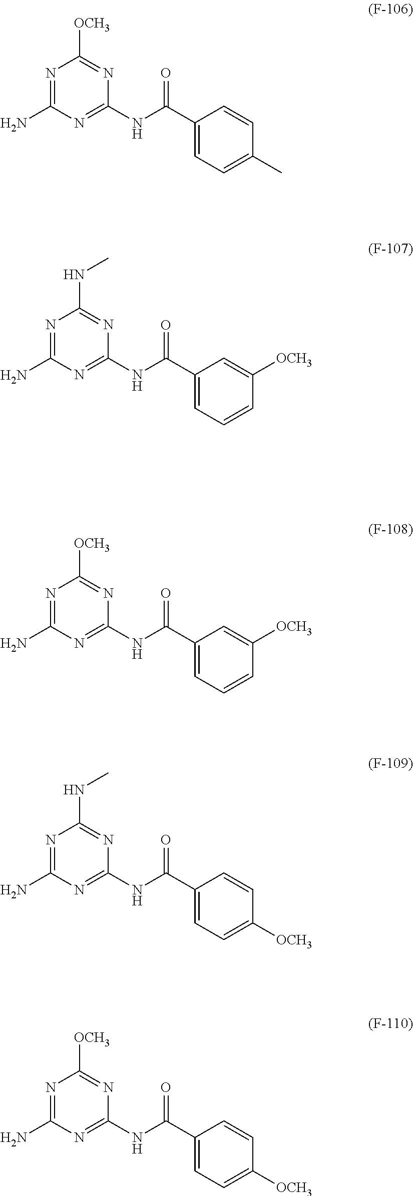

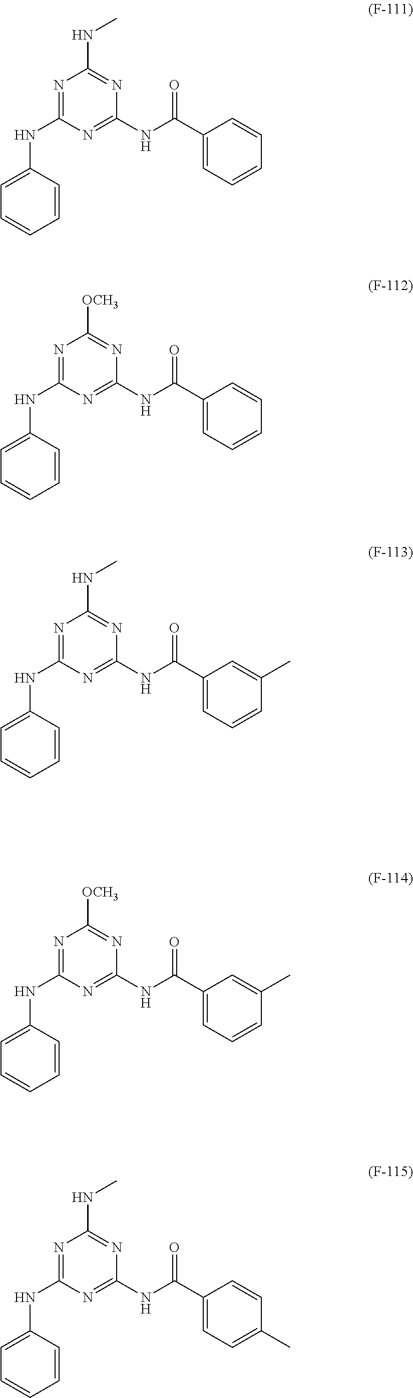

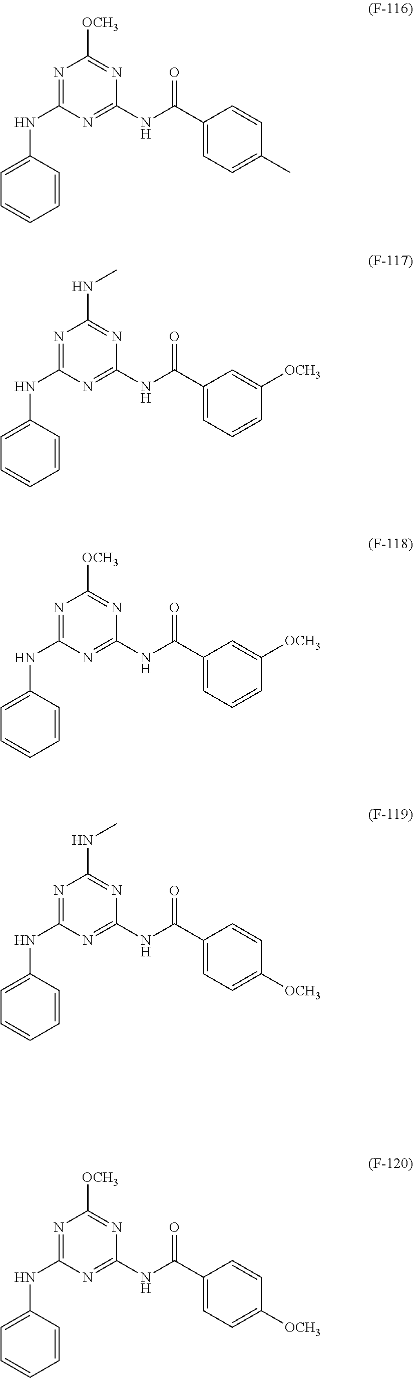

Also included in examples of the compound having an amino group that can be preferably used in the invention is a compound represented by formula (10):

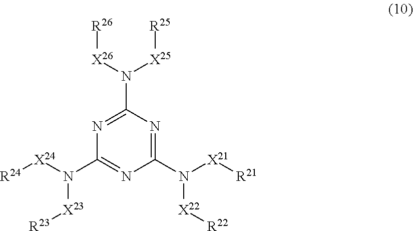

wherein X²¹, X²², X²³, X²⁴, X²⁵, and X²⁶ each independently represent a single bond or a divalent linking group; and R²¹, R²², R²³, R²⁴, R²⁵, and R²⁶ each independently represent hydrogen, alkyl, alkenyl, alkynyl, aryl, acyl, or heterocyclic group.

Examples of the divalent linking group as each of X²¹ through X²⁶ are the same as those described for X¹ in formula (1). Each of X²¹ through X²⁶ is preferably a single bond. Examples of R²¹ through R²⁶ are the same as those described with respect to R¹ in formula (1). It is preferred that each of R²¹, R²³, and R²⁵ be hydrogen and that each of R²², R²⁴, and R²⁶ be aryl.

Specific but non-limiting examples of the compound of formula (10) are shown below.

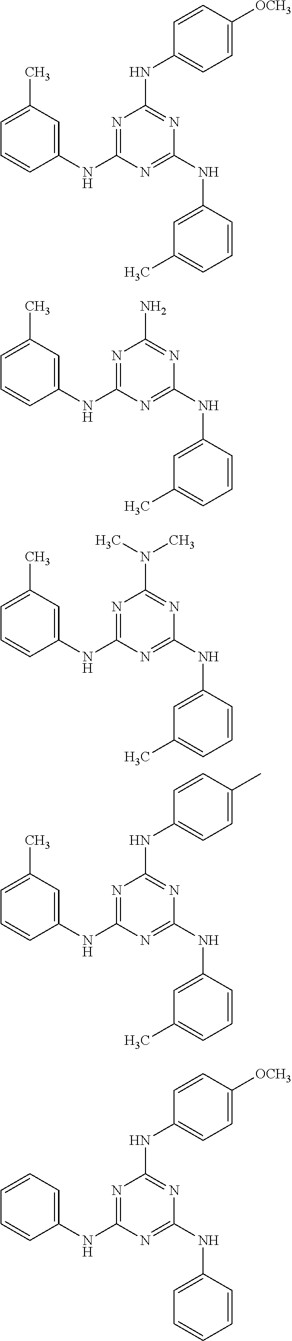

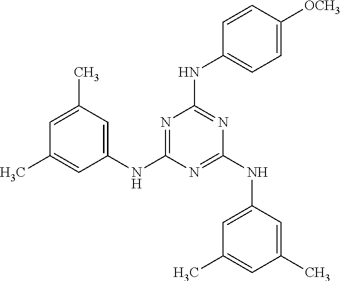

The optical film of the invention preferably contains a compound that reduces humidity dependence of retardation. Such a compound may be a compound having ΔRth(A) of −100 nm or more and less than 0 nm, the ΔtH(A) being defined by formula (IA):

ΔRth(A)=(ΔRth(rh,A)−ΔRth(rh,0))/Q (IA)

where ΔRth(rh,A) is a difference obtained by subtracting the Rth of a film containing the compound measured at 25° C. and 80% RH from that measured at 25° C. and 10% RH; ΔRth (rh,0) is a difference obtained by subtracting the Rth of a film not containing the compound measured at 25° C. and 80% RH from that measured at 25° C. and 10% RH; and Q is the mass of the compound, with the mass of the cellulose ester in the film being taken as 100.

The above defined compound is able to reduce ΔRth effectively even in a small amount. This is advantageous for minimizing the total amount of additives relative to the cellulose ester, which offers advantages, such as minimized vaporization of additives during film formation, improved film transporting properties, and reduced bleeding of the additives. The ΔRth(A) value is preferably −50 to 10 nm, more preferably −30 to 0 nm.

Compounds having a ΔRth(A) value within the above range are exemplified by compounds containing a hydrogen-bonding group at a high density per molecule. The hydrogen bonding group is preferably a group containing at least one —OH group or at least one —NH group, more preferably hydroxyl (—OH), carboxyl (—COOH), carbamoyl (—CONHR), sulfamoyl (—SONHR), ureido (—NHCONHR), amino (—NHR), urethane (—NHCOOR), or amido (—NHCOR), where R represents hydrogen, hydroxyl, amino, C1-C10 alkyl, C6-C15 aryl, or heterocyclic group, preferably hydrogen. The hydrogen bonding group is even more preferably amino, hydroxyl, carboxyl, carbamoyl, sulfamoyl, or ureido, still more preferably amino or hydroxyl. It is particularly preferred that at least one hydroxyl group of the hydrogen bonding group be a phenolic hydroxyl group.

Examples of the hydroxyl-containing compound that are preferably used in the invention, particularly phenolic hydroxyl-containing compound that are more preferred include those described in JP 2008-89860A, pp. 13-19 (compounds A) and those represented by formula (I) described in JP 2008-233530A, pp. 7-9.

The optical film of the invention may further contain an addition polymer of an acrylic ester or an addition polymer of a methacrylic ester in addition to the condensation product. The optical film may contain one or more of polymeric additives, such as polyether compounds, polyurethane compounds, polyether polyurethane compounds, polyamide compounds, polysulfone compounds, polysulfonamide compounds (these compounds include oligomers), and others. The other polymeric additives include aliphatic hydrocarbon polymers, alicyclic hydrocarbon polymers, acrylic polymers, such as polyacrylic esters and polymethacrylic esters (the ester group of which may be methyl, ethyl, propyl, butyl, isobutyl, pentyl, hexyl, cyclohexyl, octyl, 2-ethylhexyl, nonyl, isononyl, t-nonyl, dodecyl, tridecyl, stearyl, oleyl, benzyl, or phenyl); vinyl polymers, such as polyvinyl isobutyl ether and poly(N-vinylpyrrolidone); styrene polymers, such as polystyrene and poly(4-hydroxystyrene); polyethers, such as polyethylene oxide and polypropylene oxide; polyamide; polyurethane; polyurea; phenol-formaldehyde condensation products; urea-formaldehyde condensation products; and polyvinyl acetate.

The above described polymeric additive may be a homopolymer or a copolymer. They may be used either singly or in combination of two or more thereof. The effects obtained are the same whether they are used singly or as combined. Preferred of them are polyacrylic esters, polymethacrylic esters, and copolymers of a (meth)acrylic ester and other vinyl monomers. More preferred are polymeric plasticizers based on an acrylic polymer, such as poly(meth)acrylic esters having, e.g., methyl, ethyl, propyl, butyl, hexyl, cyclohexyl, 2-ethylhexyl, isononyl, oleyl, as an ester group. An addition polymer of a (meth)acrylic ester is particularly preferred.

### [III] Cellulose Ester

The optical film of the invention contains a cellulose ester. The cellulose ester content in the film is preferably 30% to 77%, more preferably 40% to 75%, even more preferably 50% to 75%, by mass. Within this cellulose ester content, an optical film exhibiting good processability into polarizing plates is obtained.

The cellulose ester that can be used in the invention is an ester of cellulose with an acid, preferably an ester with a carboxylic acid having about 2 to 22 carbon atoms, namely a cellulose acylate, more preferably an ester with a lower (C≦6) fatty acid. The degree of acyl (derived from acetic acid and/or other C3-C22 carboxylic acids) substitution, i.e., the degree of acyl substitution of the hydroxyl groups of cellulose is determined in accordance with the method of ASTM D-817-91 or the NMR method. The light unevenness of LCDs can be reduced by combining a cellulose acylate having about 2 to 22 carbon atoms in its acylate moiety with the condensation product of the invention. In particular, when in using cellulose acetate (C=2), an adduct having a repeating unit (e.g., acrylic ester addition polymer or methacrylic acid addition polymer) is preferably used in combination with the condensation product to achieve further reduction of light unevenness.

Cellulose that can be used as a raw material of the cellulose ester for use in the invention is not particularly limited. Any cellulose material, such as cotton linter or wood pulp (either hardwood or softwood pulp), may be used. A mixture of different raw cellulose materials may be used in some cases. For the details of the raw cellulose materials, reference may be made in Marusawa and Uda, Plastic Zairyo Koza (17) Sen'isokei Jyushi, The Nikkan Kogyo Shimbun, Ltd., 1970 and Journal of Technical Disclosure 2001-1745, Japan Institute of Invention and Innovation, pp. 7-8.

While the degree of acyl substitution of the cellulose acylate is not particularly limited, a film superior in moisture permeation or absorption is obtained from a cellulose acylate with a high acyl substitution degree, which is advantageous for use as an optical film such as a polarizer-protective film of a polarizing plate. From this standpoint, the degree of acyl substitution is preferably 2.50 to 3.00, more preferably 2.70 to 2.96, even more preferably 2.80 to 2.94.

The C2-C22 acyl group or groups substituting the hydrogen atom of the hydroxyl groups of cellulose which is/are derived from acetic acid and/or a C3-C22 carboxylic acid may be either aliphatic or aromatic and may be of a single kind or a mixture of two or more acyl groups. The acyl group may be, for example, alkylcarbonyl, alkenylcarbonyl, aromatic carbonyl, or aromatic alkylcarbonyl, each of which may be substituted. Examples of preferred acyl groups include acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, t-butanoyl, cyclohexanecarbonyl, oleoyl, benzoyl, naphthylcarbonyl, and cinnamoyl. More preferred of them are acetyl, propionyl, butanoyl, dodecanoyl, octadecanoyl, t-butanoyl, oleoyl, benzoyl, naphthylcarbonyl, and cinnamoyl. Even more preferred are acetyl, propionyl, and butanoyl. In view of ease of synthesis, cost, and ease of substituent distribution control, acetyl or a combination of acetyl and propionyl is particularly preferred. Acetyl is the most preferred.

The cellulose acylate preferably used in the invention preferably has a degree of polymerization of 180 to 700 in terms of viscosity average degree of polymerization. In the case of cellulose acetate, the degree of polymerization is preferably 180 to 550, more preferably 180 to 400, even more preferably 180 to 350. When the degree of polymerization is too high, the cellulose acylate solution (also referred to as a dope) tends to be too viscous to be cast in film formation. With the degree of polymerization being too low, reduction of film strength may be experienced. The viscosity average degree of polymerization may be determined by the intrinsic viscosity method (Kazuo Uda and Hideo Saito, Sen'i Gakkaishi, vol. 18, No. 1, pp. 105-120, 1962). The details of this method are described in JP 9-95538A.

The molecular weight distribution of the cellulose acylate preferably used in the invention is determined by gel permeation chromatography. The molecular weight distribution of the cellulose acylate is preferably as narrow as possible. The molecular weight distribution is typically evaluated by polydispersity index defined to be the ratio of mass average molecular weight Mw to number average molecular weight Mn. The polydispersity index of the cellulose acylate is preferably 1.0 to 4.0, more preferably 2.0 to 3.5, even more preferably 2.3 to 3.4.

Removal of low-molecular components results in an increase of average molecular weight (degree of polymerization) but reduces the viscosity compared with that of an ordinary cellulose acylate. Therefore, the cellulose acylate to be used is advantageously freed of low-molecular components. A cellulose acylate with reduced low-molecular components is obtained by removing low-molecular components from a cellulose acylate synthesized in a usual synthesis method by washing with an appropriate organic solvent. In preparing a cellulose acylate with reduced low-molecular components, the amount of a sulfuric acid catalyst used in the acylation reaction is preferably adjusted within a range of from 0.5 to 25 parts by mass per 100 parts by mass of cellulose. Adjusting the amount of the catalyst within that range has the advantage of allowing for synthesis of a cellulose acylate with a narrow molecular weight distribution.

At the time when the cellulose acylate is used in the film formation, the water content thereof is preferably not more than 2% by mass, still preferably 1% by mass or lower, even still preferably 0.7% by mass or lower. In general, a cellulose acylate has a water content, which is known to be 2.5% to 5% by mass. Therefore, drying is needed to achieve a water content of 2% or lower. The manner of drying is not restricted as long as a desired water content is reached.

For the details of the raw material cotton and the synthesis of cellulose acylates, reference can be made to Journal of Technical Disclosure, No. 2001-1745, pp. 7-12, Japan Institute of Invention and Innovation, March, 2001.

Two or more cellulose acylates different in acyl substituent, acyl substitution degree, polymerization degree, molecular weight distribution, and the like may be combined for use in the invention.

While the optical anisotropy of the optical film of the invention is controllable by the addition of the above described condensation product, a retardation controlling agent (or an optical anisotropy controlling agent) other than the condensation product may be utilized according to desired retardation characteristics. Specifically, a compound that reduces Rth or a compound that raises Rth may be added. The former is exemplified by the compounds described in JP 2006-30937A, pp. 23-72. The latter is preferably a compound having at least one aromatic ring, more preferably 2 to 15 aromatic rings, even more preferably 3 to 10 aromatic rings. The atoms other than the aromatic rings of the compound are preferably arranged on a plane near the plane of the aromatic ring. When the compound has two or more aromatic rings, the planes of the aromatic rings are preferably near each other. In order to selectively increase the Rth, it is preferred for the compound in the film to align with the plane of the aromatic ring(s) parallel to the film surface. The retardation controlling agents may be used either singly or in combination of two or more thereof.

Examples of the Rth-raising additive include the plasticizers described in JP 2005-104148A, pp. 33-34 and the optical anisotropy controlling agents described in ibid., pp. 38-89. In the invention, addition of a low molecular compound having an Rth raising effect is effective in reducing the visibility of circular light unevenness that may be observed when an LCD is obliquely viewed, the mechanism of which is unclear. Furthermore, addition of such a compound allows for proper control of the hereinafter described moist heat stability of Rth.

### [IV] Retardation and Other Characteristics

It is important that the optical film of the invention should have an Re and an Rth at a wavelength of 590 nm, which are defined by formula (I) and (II) below, respectively, adjusted as appropriate for the intended use. The Re and Rth are adjustable by, for example, selecting the kind or degree of substitution of the ester group of the cellulose ester, the kind or amount of the condensation product, the thickness of the film, or the processing conditions in film formation or by incorporating the step of stretching.

When it is desired for an optical film to have reduced retardation for use, for example, in an IPS mode LC panel, the film preferably has retardation characteristics satisfying formulae (IIIa) and (Iva) below. It is also possible that an optical film used as a protective film may serve as a support on which a functional layer such as described infra may be provided to improve, for example, the display contrast, viewing angle characteristics, or tint of LCDs.

Re=(nx−ny)×d (nm) (I)

Rth={(nx+ny)/2−nz}×d (nm) (II)

where nx is the refractive index along the in-plane slow axis; ny is the refractive index along the in-plane fast axis; nz is the refractive index in the film thickness direction; and d is the film thickness (nm).

Re<10 (IIIa)

|Rh|<25 (Iva)

In the above formulae, the azimuth angle of the in-plane slow axis is not particularly limited but is preferably nearly parallel or perpendicular to the azimuth direction in which the in-plane elastic modulus is the highest. The Re is preferably 0 to 5 nm, and the Rth is preferably −15 to 5 nm, more preferably −10 to 0 nm. In use as a liquid crystal cell side protective film of a polarizing plate of an LCD, the optical film having the Re and Rth falling within the above range reduces light leakage from an oblique direction thereby improving display qualities.

When it is desired for an optical film to have positively increased retardation for use, for example, in a VA mode LC panel, the film preferably satisfies formulae (IIIb) and (IVb) shown below. It is also possible that an optical film used as a protective film may serve as a support on which a functional layer such as described later may be provided to improve, for example, the display contrast, viewing angle characteristics, or tint of LCDs.

30≦Re≦85 (IIIb)

80≦Rth≦300 (IVb)

In this case, the azimuth angle of the in-plane slow axis is not particularly limited but is preferably nearly parallel or perpendicular to the azimuth direction in which the in-plane elastic modulus is the highest.

When it is desired for an optical film to have positively developed retardation for use, for example, in an IPS mode LC panel, the film preferably satisfies formulae (IIIc) and (Vc) shown below. It is also possible that an optical film used as a protective film may serve as a support on which a functional layer such as described later may be provided to improve, for example, the display contrast, viewing angle characteristics, or tint of LCDs.

60≦Re≦400 (IIIc)

−0.5≦Rth/Re≦0.5 (Vc)

In this case, the azimuth angle of the in-plane slow axis is not particularly limited but is preferably nearly parallel or perpendicular to the azimuth direction in which the in-plane elastic modulus is the highest.

The Re and Rth (unit: nm) are determined as follows: A film sample is conditioned at 25° C. and 60% RH for 24 hours before the measurement. The average refractive index (n) defined by formula (2) below of the sample film at 532 nm is determined with Prism Coupler Model 2010 from Metricon at 25° C. and 60% RH using a solid state laser.

n=(n_{TE}×2+n_{TM})/3 (2)

where n_{TE} is the refractive index measured using light polarized in the plane direction of the film; and n_{TM} is the refractive index measured using light polarized in the normal direction of the film.

As used herein, the terms “Re (λnm)” and “Rth(λnm)” denote an in-plane retardation and a thickness direction retardation, respectively, at a wavelength λ (unit: nm). Re (λnm) is measured for light having a wavelength of λ nm incident normal to the film surface using KOBRA 21ADH or WR (both from Oji Scientific Instruments).

When a film subject to determination is represented by a uniaxial or biaxial index ellipsoid, Rth(λnm) is calculated as described below. A total of six retardation values are measured for light of a wavelength λ nm incident in varied directions using KOBRA 21ADH OR WR: first is the Re (λnm) obtained above and second to sixth are retardation values measured for light incident in one direction tilted (rotated) at an angle increasing in 10° increments up to 50° from the normal direction of the film about the in-plane slow axis, which is decided by KOBRA 21ADH or WR, as an axis of tilt (rotation). Where there is no slow axis, any in-plane direction of the film will be an axis of rotation. Rth(λnm) is computed by KOBRA 21ADH or WR based on the resulting retardation values, the average refractive index, and the film thickness.

In the above description, the terms Re and Rth without being suffixed with (λnm) denote values measured using light of 590 nm. In the case where a film shows a zero retardation at a certain tilt angle from the normal direction about the in-plane slow axis as an axis of rotation, the retardation value at a tilt angle greater than that certain angle is prefixed with a minus sign prior to the computation with KOBRA 21ADH or WR.

The Rth may also be calculated from two retardation values measured in two different directions at any tilt angle about the slow axis as the axis of tilt (when there is no slow axis, any in-plane direction of the film will be taken as an axis of tilt), the average refractive index, and the thickness of the film based on the following formulae (3) and (4).

### Formula (3):

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}}$$

where Re (θ) represents a retardation value for light incident in a direction titled by an angle θ from the normal direction; nx represents the refractive index along the in-plane slow axis direction; ny is the refractive index along a direction perpendicular to nx; nz represents the refractive index along a direction perpendicular to nx and ny; and d is a thickness of the film.

Rth=((nx+ny)/2−nz)×d (4)

When a film subject to determination is not represented by a uni- or biaxial index ellipsoid, i.e., when the film has no optic axis, Rth(λnm) may be calculated as follows: A total of eleven retardation values are measured for light of a wavelength λ nm incident in varied directions: first is the Re (λnm) obtained above and second to eleventh are retardation values measured for incident light tilted (rotated) at an angle increasing in 10° increments from −50° to +50° with respect to the normal direction of the film about the in-plane slow axis, which is decided by KOBRA 21ADH or WR, as an axis of tilt (rotation). Rth(λnm) is computed by KOBRA 21ADH or WR based on the resulting eleven retardation values, the average refractive index, and the thickness of the film. With the average refractive index and the film thickness inputted, KOBRA 21ADH or WR computes nx, ny, and nz, from which is computed Nz=(nx−nz)/(nx−ny).

The average refractive indices used in the above described calculations are known from Polymer Handbook, John Wily & Sons, Inc. or available catalogues of various optical films. Otherwise, the average refractive indices can be obtained by the aforementioned method. Typical optical films and their average refractive indices are: cellulose acylate (1.48), cycloolefin polymer (1.52), polycarbonate (1.59), polymethyl methacrylate (1.49), and polystyrene (1.59).

The humidity dependence of Re (ΔRe) and that of Rth (ΔRth) are calculated from the retardations at a relative humidity H (unit: %), i.e., Re (H %) and Rth(H %), according to formulae:

ΔRe=Re(10%)−Re(80%)

ΔRth=Rth(10%)−Rth(80%)

The Re (H %) and Rth(H %) are values at 590 nm obtained in the same manner as described above, except that the film is conditioned at 25° C. and a relative humidity (RH) of H % for 24 hours and that the measurement is taken at 25° C. and H % RH. The terms Re and Rth without being suffixed with (H %) denote values measured at 60% RH.

The humidity dependence of the optical film of the invention is preferably such that each of the ΔRe and the ΔRth is in the range of from −30 to 30 nm, more preferably from −15 to 15 nm, even more preferably −10 to 10 nm, most preferably −5 to 5 nm. With the above defined humidity dependence values ΔRe and ΔRth being controlled within the ranges recited, the optical film has reduced retardation variations with the environmental changes, whereby a highly reliable LCD is provided.

To reduce the ΔRth of the optical film offers an additional advantage that circular color unevenness perceptible when an LCD is seen from a direction oblique to the display surface under a specific condition is reduced.

The moist heat stability of Rth of the optical film is evaluated by the change in Rth that occurs when the film is kept in moist heart. To ensure improved reliability of image display devices and also to reduce visibility of circular light unevenness that may be observed when an LCD is seen from an oblique direction, a smaller Rth change is more desirable. Specifically, the moist heat stability is preferably 20 nm or smaller, more preferably −20 to 15 nm, even more preferably −15 to 10 nm, still even more preferably −10 to 8 nm, and most preferably −7 to 5 nm, in terms of Rth change as measured and calculated as follows:

A polarizing plate is prepared, which is composed of a polarizer, an optical film of the invention as a protective film on one side of the polarizer, and a commonly used cellulose acylate film (e.g., Fuji Tack TD60UL) as a protective film on the other side. An adhesive is transferred onto the optical film of the invention, and the polarizing plate is attached to a glass plate via the adhesive. The thus prepared sample is allowed to stand at 80° C. and 90% RH for 130 hours. Then, the common cellulose acylate film and the polarizer are stripped off the sample. After visually ascertaining the transparency of the film remaining on the glass plate, the retardation is determined in the same manner as described above, and the moist heat stability of Rth is calculated according to the following formula, in which Rth is a value measured for light of 590 nm, and “Rth of film immediately after film formation” is a value measured at 25° C. and 60% RH.

Moist heat stability of Rth=(Rth of film remaining on glass plate)−(Rth of film immediately after film formation) (nm)

The dimensional change of the optical film of the invention is represented by the percentage of the dimensional change encountered by the film when allowed to stand at 60° C. and 90% RH for 24 hours relative to the initial dimension of the film. To reduce the thus defined dimensional change has turned out effective in reducing retardation change in moist heat. From this viewpoint, the dimensional change of the optical film of the invention is preferably 3% or less, more preferably 0.05% to 3%, even more preferably 0.05% to 1%, most preferably 0.05% to 0.5%. The above described effect is sufficiently produced when the dimensional change is reduced to 0.05%.

The above defined dimensional change is determined as follows: A specimen measuring 25 cm in length and 5 cm in width is cut out of a film with the length coinciding with the direction having the highest elastic modulus. Two pin holes are made in the specimen with a 20 cm spacing. After conditioning the specimen at 25° C. and 60% RH for 24 hours, the distance L0 between the holes is measured with a pin gauge. The specimen is then maintained at 60° C. and 90% RH for 24 hours, and, after conditioning at 25° C. and 60% RH for 2 hours, the distance L1 between the holes is again measured. The dimensional change is calculated by formula:

Dimensional change (%)={(L1−L0)/L0}×100

In order to reduce the dimensional change of a film, it is effective to subject the film to heat treatment or steam contact treatment hereinafter described.

It has been revealed that the circular color unevenness observed when an LCD is viewed obliquely is made less perceptible by reducing not only the humidity dependence of Rth but the coefficient of hygroscopic expansion of the optical film. The coefficient of hygroscopic expansion is determined as follows: A specimen measuring 25 cm in length and 5 cm in width is cut out of a film with the length coinciding with the direction having the highest elastic modulus. Two pin holes are made in the specimen with a 20 cm spacing. After conditioning the specimen at 25° C. and 10% RH for 24 hours, the distance L0 between the holes is measured with a pin gauge. The specimen is then maintained at 25° C. and 80% RH for 24 hours, and the distance L1 between the holes is again measured. The coefficient of hygroscopic expansion is calculated by formula:

Coefficient of hygroscopic expansion (ppm/% RH)={(L1−L0)/L0}/70×10⁶

wherein 70 is the difference of humidities (%) of measurement.

The coefficient of hygroscopic expansion of the optical film of the invention is preferably 55 ppm/% RH or less, more preferably 3 to 50 ppm/% RH, even more preferably 5 to 45 ppm/% RH. The hygroscopic expansion coefficient may be reduced by, for example, increasing the crystallinity of the cellulose acylate used in the optical film or subjecting the optical film to stretching.

Although the relation between the hygroscopic expansion coefficient or tensile elastic modulus (hereinafter described) of the optical film and the visibility of color unevenness observed in obliquely viewing an LCD is unclear, it is considered that a film having a reduced hygroscopic expansion coefficient or reduced tensile elastic modulus and being in a form fixed to a rigid support, such as a glass plate or a polarizer, is capable of reducing the internal stress generated with environmental humidity changes, whereby the humidity dependence of retardation of the film further reduces.

### [V] Other Additives

The optical film of the invention preferably contains particles as a matting agent. Examples of suitable particulate matting agents include silicon dioxide, titanium dioxide, aluminum oxide, zirconium oxide, calcium carbonate, talc, clay, calcined kaolin particles, calcined calcium silicate, calcium silicate hydrate, aluminum silicate, magnesium silicate, and calcium phosphate. Silicon-containing particles are preferred in terms of low haze. Silicon dioxide particles are particularly preferred. Silicon dioxide particles preferably have an average primary particle size of 20 nm or smaller and an apparent specific gravity of 70 g/L or more. To reduce the haze of the film, the average primary particle size is more preferably as small as 5 to 16 nm. The apparent specific gravity is more preferably 90 to 200 g/L, even more preferably 100 to 200 g/L. A higher apparent specific gravity allows for preparation of a higher concentration dispersion, which leads to reduction of haze and agglomerates.

The particles usually agglomerate to form secondary particles with an average particle size of 0.1 to 3.0 μm. In a film, the fine particles exist as agglomerates of the primary particles to provide the film with a surface unevenness of 0.1 to 3.0 μm. The secondary particle size is preferably 0.2 to 1.5 μm, more preferably 0.4 to 1.2 μm, even more preferably 0.6 to 1.1 μm. The circumscribed circle diameter of a primary or secondary particle under a scanning electron microscope is taken as a particle size of the primary or secondary particle. A total of 200 particles at different sites are measured to obtain an average particle size.

Commercially available silicon dioxide particles can be made use of, including AEROSIL R972, R972V, R974, R812, 200, 200V, 300, R202, OX50 and TT600 (all available from Nippon Aerosil Co., Ltd.). Commercially available zirconium oxide particles, such as AEROSIL R976 and R811 (both from Nippon Aerosil Co., Ltd.), are useful.

Among the commercial products, AEROSIL 200V and AEROSIL R972, which are silicon dioxide particles, are particularly preferred as having an average primary particle size of 20 nm or smaller and an apparent specific gravity of 70 g/L or more and being highly effective in reducing frictional coefficient of the film while maintaining low haze.

Some techniques are proposed in preparing a matting agent dispersion to obtain an optical film containing small secondary particles of the matting agent. In a method, the fine particles of a matting agent and a solvent are mixed by stirring to prepare a dispersion, the matting agent dispersion is added to a small portion of a separately prepared cellulose acylate dope and dissolved by stirring, and the mixture is admixed to the rest of the dope. According to this method, silicon dioxide particles can be dispersed well and hardly re-agglomerate. In another method, a small amount of a cellulose ester is dissolved in a solvent by stirring, the particles are added thereto and dispersed in a dispersing machine, and the resulting dispersion is thoroughly mixed with the dope in an in-line mixer. The present invention is not restricted by these methods. In dispersing the silicon dioxide particles in a solvent or a solution, the silicon dioxide concentration is preferably 5% to 30% by mass, more preferably 10% to 25% by mass, even more preferably 15% to 20% by mass. A higher dispersion concentration results in a lower liquid turbidity for the amount of addition, leading to reductions in haze and agglomerates.

The amount of the matting agent in the final cellulose acylate dope is preferably 0.01 to 1.0 g/m², more preferably 0.03 to 0.3 g/m², even more preferably 0.08 to 0.16 g/m². In the case when a cellulose acylate film is a multi-layered film formed by, for example, co-casting, it is preferred that the particulate matting agent not be added to the inner layer but only to the surfacing layer. In this case, the amount of the matting agent to be added to the surfacing layer is preferably 0.001% to 0.2% by mass, more preferably 0.01% to 0.1% by mass.

Suitable solvents to be used in the preparation of the matting agent dispersion include lower alcohols, such as methyl alcohol, ethyl alcohol, propyl alcohol, isopropyl alcohol, and butyl alcohol. In using other organic solvents, the same solvent as used in the cellulose acylate dope preparation is preferred.

The optical film of the invention may further contain various other additives in addition to the above described condensation product, retardation controlling agent, and matting agent, such as plasticizers, UV absorbers, deterioration inhibitors, release agent, IR absorbers, wavelength dispersion controlling agent, and the like. The additives may be each either solid or oily. In other words, the additives are not limited by their melting point or boiling point. For example, a UV absorber whose melting point is below 20° C. and another UV absorber whose melting point is above 20° C. may be used in combination. The same applies to a combination of plasticizers. Examples of such combinations are described, e.g., in JP 2001-151901A. Useful IR absorbing dyes are described, e.g., in JP 2001-194522A. The additives may be added at any stage during dope preparation. Otherwise, a step of adding additives may be provided as a final stage of dope preparation. The amount of each additive is not particularly limited as long as the expected effect is manifested. When the optical film has a multilayer structure, the kinds and amounts of the additives may differ between layers. The techniques relating to usage of these additives in optical films are known from, for example, JP 2001-151902A. For further information about preferred materials of the additives, reference may be made to Journal of Technical Disclosure, No. 2001-1745, pp. 16-22, issued on 2001 Mar. 15 by Japan Institute of Invention and Innovation.

The total amount of the above described other additives, if used in addition to the condensation product, retardation controlling agent, and matting agent, is preferably 30% to 200% by mass, more preferably 35% to 150% by mass, relative to the total amount of polymeric components of the film having a molecular weight more than 5000, inclusive of the cellulose acylate.

### [VI] Optical Film Formation

The optical film of the invention is preferably formed by solvent casting using a solution of a polymer comprising the cellulose acylate in an organic solvent, called a dope. While the organic solvent that is preferably used as a main solvent of the dope is not particularly limited as long as the polymer comprising the cellulose acylate is soluble therein, it is preferably chosen from C3-C12 esters, ketones, and ethers and C1-C7 halogenated hydrocarbons. The esters, ketones, and ethers may contain a cyclic structure. Compounds having at least two of ester, ketone, or ether functional groups (i.e., —O—, —CO—, and —COO—) are also useful as a main solvent. The solvent may contain other functional groups such as an alcoholic hydroxyl group.

The solvent may be either a system containing a chlorine-containing halogenated hydrocarbon as a main solvent or, as described in Journal of Technical Disclosure, No. 2001-1745, pp. 12-16, a system containing a chlorine-free organic solvent as a main solvent.

Solvents for the cellulose acylate solution and film and dissolving methods that are preferably used in the invention are described in JP-A Nos. 2000-95876, 12-95877, 10-324774, 8-152514, 10-330538, 9-95538, 9-95557, 10-235664, 12-63534, 11-21379, 10-182853, 10-278056, 10-279702, 10-323853, 10-237186, 11-60807, 11-152342, 11-292988, 11-60752, and 11-60752. These patent documents furnish information about not only solvents preferable for dissolving the cellulose acylate of the invention but also properties of the solutions and substances that may added to the solutions. These teachings can be incorporated in the present invention to realize preferred embodiments.

The cellulose acylate solution (dope) can be prepared by any method, for example, a room-temperature dissolving method, a cold dissolving method, a hot dissolving method, or a combination thereof. With respect to the cellulose acylate dope preparation including concentration and filtration steps involved in dope preparation, the techniques described in Journal of Technical Disclosure, No. 2001-1745, pp. 22-25, Japan Institute of Invention and Innovation, March, 2001 are preferably used in the invention.

Solvent casting using a cellulose acetate dope may be carried out using various methods and equipment conventionally employed in the formation of a cellulose triacetate film. A dope prepared in a dissolving machine is once stored in a storage tank where the dope is defoamed. The thus obtained final dope is fed to a pressure die through a pressure pump, e.g., a constant displacement gear pump capable of precise metering by the number of rotations and uniformly cast through the slot of the pressure die on an endlessly moving metal support. When the dope on the support makes almost one revolution and reaches a peeling position, by which time the dope has half-dried, the half-dried dope called a web is peeled off the support. The dope extruded from the die slot may be of a single kind or comprise two or more dopes having different compositions in layers (co-casting). The web is dried while being advanced by a tenter with its width fixed by clips, finally dried while moving on a group of pass rollers in a dryer, and taken up on a winder to form a roll of prescribed length. The combination of the tenter and the dryer having rollers is subject to alteration depending on the purpose. In another embodiment, the dope is cast from a die onto a drum (metal support) cooled to 0° C. or lower and thus gels. When the dope on the support makes almost one revolution, the web is removed from the drum, stretched by a pin tenter while being advanced, and dried.

It is preferred that the web of the film be subjected at least once to the step of edge cutting (the step of slitting both edges of the web) between the step of peeling off the metal support and the step of winding into roll. More preferably, the web is passed through the edge cutting step at least twice: once downstream of the outlet of a tenter and once downstream of the step of drying between rollers. The edge cutting step is implemented by placing an edge slitter unit. Examples of suitable edge slitters include, but are not limited to, NT® cutters, cutting rollers, and laser beams. The edge slitter is preferably set at both edge portions of the film. An example of the edge slitter unit includes a rotating disk blade made of carbide steel as an upper blade and a rotating cutting roller as a lower blade.

In carrying out solvent casting to make a functional protective film of a polarizing plate for use in electronic displays or a silver halide photographic light-sensitive material, which are the primary uses of the optical film of the invention, the solvent casting equipment is often combined with coaters to provide the cast film with a functional layer, such as an undercoating layer, an antistatic layer, an anti-halation layer, or a protective layer. Journal of Technical Disclosure, No. 2001-1745, pp. 25-30 provides useful information on such solvent casting techniques under subtitles: casting (inclusive of co-casting), metal support, drying, peeling, and the like, which is preferably used in the invention.

Where needed, the process of producing the optical film of the invention may include the step of subjecting the optical film to heat treatment. While the effects of the heat treatment are not particularly specified, it is believed that, upon heat energy acquisition, the film allows the higher order structure of cellulose acylate molecules to be transformed into a more stable structure, which favors the reductions of dimensional changes of the film and changes of retardation of the film kept in moist heat. In carrying out the heat treatment, it is important to control temperature and tension as appropriate to the film. The temperature is preferably higher than the hereinafter described glass transition temperature measured using a differential scanning calorimeter so that the heat treatment may complete in a shorter period of time. The tension is preferably set low so as to obtain sufficient effects as expected of the heat treatment.

If desired, the process may include the step of contacting the optical film with a contacting gas, such as steam (steam contact step). While the effects of the steam contact step are not particularly limited, this step allows for achieving reduction in dimensional changes and retardation changes due to moist heat in a shorter treating time. Without being bound by any theory, it appears that these effects are attributed to the following mechanism. On contact with a contacting gas hereinafter described, the optical film absorbs the contacting gas molecules, decreases in glass transition temperature, and thereby acquires heat energy. As a result, diffusion of the contacting gas molecules in the optical film containing the cellulose acylate is accelerated, thereby helping the cellulose acylate molecules to transform from the higher-order structure to a more stable structure. Therefore, the steam contact step achieves structural stabilization of the cellulose acylate molecules in a shorter period of time than a mere heat treatment. While the steam contact step may be effected in any stage in the production of the optical film, it is preferably carried out after the above described stretching or heat treatment or after completion of the step of contacting with an organic solvent hereinafter described, more preferably after the stretching or heat treatment. The steam contact step may be preceded or followed by the surface treatment hereinafter described.

The step of contacting the optical film with a contacting gas will be described chiefly with reference to the step in which a cellulose acylate film is brought into contact with a gas containing water vapor (steam), i.e., the steam contact step.

The contacting gas by which the optical film is contacted in the steam contact step is not particularly limited as long as it is a vaporized liquid solvent. The contacting gas is preferably a steam-containing gas, more preferably a gas containing steam as a major component, even more preferably steam. In the case of a contacting gas composed solely of a single gas, the term “a major component” indicates the single gas per se. In the case of a mixed gas, the term “major component” means the gas having the largest mass fraction.

The contacting gas is preferably generated in a wet gas feeding device. In a wet gas feeding device, a liquid solvent is heated in a boiler into vapor, which is fed by a blower. The contacting gas may be mixed with an appropriate amount of air. The contacting gas from the blower may be passed through a heater to be heated further. The air to be mixed is preferably heated air. The temperature of the thus prepared contacting gas is preferably 70° to 200° C., more preferably 80° to 160° C., even more preferably 100° to 140° C. Strong curling may occur at temperatures above 200° C. At temperatures below 70° C., sufficient effects may not be obtained. The contacting gas which contains water vapor preferably has a relative humidity of 20% to 100%, more preferably 40% to 100%, even more preferably 60% to 100%.

As used herein, the term “liquid solvent” includes water and a solvent containing an organic or inorganic solvent. Water may be soft water, hard water, or pure water. Soft water is preferred in favor of boiler protection. It is recommended to use water as free from impurities as possible because film contamination with impurities may cause deterioration of optical and mechanical characteristics of the optical film as a commercial product. In this regard, it is preferred to use soft water or pure water, particularly pure water. As used herein, the term “pure water” refers to water having an electric resistivity of at least 1 MΩ and, in particular, a metal (such as sodium, potassium, magnesium, and calcium) ion concentration of less than 1 ppm, and an anion (such as chloride and nitrate) concentration of less than 0.1 ppm. Pure water can easily be prepared by means of a reverse osmosis membrane, an ion exchange resin, distillation or a combination thereof. Examples of useful organic solvents include methanol, acetone, and methyl ethyl ketone. The solvent in the form of liquid may contain a condensate liquid formed by condensation of a recovered contacting gas.

Contact between the optical film and the contacting gas may be achieved by applying the contacting gas to the optical film, placing the optical film in a space filled with the contacting gas, or passing the optical film through a space filled with the contacting gas. The method of applying the contacting gas to the optical film or the method of passing the optical film through a space filled with the contacting gas is preferred. Preferably, the optical film is contacted by the contacting gas while being passed over a plurality of rollers arranged in zigzag order.

The contact time with the contacting gas is not particularly limited but, from the viewpoint of production efficiency, is preferably as short as possible within a range that produces the effects of the invention. The upper limit of the contact time is preferably, for example, 60 minutes or shorter, more preferably 10 minutes or shorter. The lower limit of the contact time is preferably, for example, 10 seconds or longer, more preferably 30 seconds or longer. The temperature of the optical film to be contacted by the contacting gas is preferably, but not limited to, 50° to 150° C.

While the residual solvent content in the optical film before contact with steam is not particularly limited, it is preferably such that the cellulose acylate molecules have little fluidity in the film. Specifically, the residual solvent content is preferably 0 to 5% by mass, more preferably from 0 to 0.3% by mass.

The contacting gas having contacted the optical film may be sent to a condenser unit connected with a cooling unit, in which the gas is separated into hot vapor and a condensate liquid.

The optical film thus treated with the contacting gas may be cooled as such to almost room temperature or, to adjust the amount of the contacting gas molecules remaining in the film, it may be conveyed into a drying zone. In the case where the film is conveyed into a drying zone, the same drying method as used in the aforementioned organic solvent contact step is preferably employed. When the steam contact step is performed before the above-mentioned stretching step or heat treatment step or the organic solvent contact step to be described hereinafter, any of such subsequent steps may serve as the drying step.

In some cases, the process of producing the optical film of the invention may include an organic solvent contact step in which the surface of the optical film is contacted with an organic solvent, followed by drying to form an adhesive layer on the optical film. Accordingly, in the case when the optical film with its one side having been contacted with an organic solvent is used as a protective film of a polarizing plate, the optical film is preferably attached to a polarizer on its organic solvent-treated side. The contact of the optical film with an organic solvent may be performed by any known ordinary method of contact, for example, dipping, air knife coating, curtain coating, roller coating, wire bar coating, gravure coating, slide coating, spraying, die coating, extrusion coating using a hopper described in U.S. Pat. No. 2,681,294, and microgravure coating. The organic solvent contact step may also be achieved by the above described steam contact step in which an organic solvent is used in place of water as a major component. In order to effectively form the adhesive layer, the concentration of the organic solvent to be contacted with the optical film is preferably higher than the solvent concentration in the optical film before being contacted with the organic solvent.

The optical film of the invention preferably has a thickness of 20 to 120 μm, more preferably 30 to 90 μm, even more preferably 35 to 80 μm. For use as a polarizer protective film of a polarizing plate attached to an LC panel, the thickness suitable to reduce light unevenness is preferably 30 to 80 μm, more preferably 35 to 65 μm, even more preferably 35 to 50 μm. With the film thickness being in this range, warpage of the liquid crystal panel that may accompany temperature and humidity changes will be reduced.

Transparency is an important property required of an optical film. The optical film preferably has a haze as low as 0.01% to 2.0%, more preferably 1.0% or less, even more preferably 0.5% or less. The haze is measured for a specimen measuring 40 mm in width and 80 mm in length with a haze meter HGM-2DP (from Suga Test Instruments Co., Ltd.) at 25° C. and 60% RH in accordance with JIS K6714.

The transmission of the optical film is measured on a specimen measuring 13 mm by 40 mm at a wavelength of 300 to 450 nm with a spectrophotometer U-3210 from Hitachi, Ltd. at 25° C. and 60% RH. The wavelength slope width is obtained by subtracting the wavelength at which the transmission is 5% from the wavelength at which the transmission is 72%. The transmission threshold wavelength is defined to be (wavelength slope width/2)+wavelength at which the transmission is 5%. The absorption end is defined to be the wavelength at which the transmission is 0.4%. The transmissions at 380 nm and 350 nm are thus evaluated.

For use as a protective film on the opposite side of a polarizer to a liquid crystal cell, it is preferred for the optical film to have a spectral transmission of 45% to 95% at 380 nm and of 10% or less at 350 nm.

The glass transition temperature (Tg) of the optical film is measured by monitoring a sample film in a differential scanning calorimeter (DSC) while heating the film at a rate of 10° C./min. The midpoint of the baseline shift in the DSC curve is taken as the Tg.

Tg may also be determined using a dynamic viscoelasticity measuring device as follows: A 5 mm wide and 30 mm long specimen cut out of the unstretched optical film of the invention is conditioned at 25° C. and 60% RH for at least 2 hours before measurement. The Tg measurement is made with a dynamic viscoelasticity measuring device Vibron DVA-225 from ITK Co., Ltd. at a sample length between grips of 20 mm, at a heating rate of 2° C./min from 30° to 250° C., and at a frequency of 1 Hz. The storage modulus is plotted on a logarithmic ordinate and temperature (° C.) on a linear abscissa. A straight line 1 and a straight line 2 showing a steep decrease in storage modulus observed at the phase transition from the solid region to the glass transition region are drawn in the solid region and the glass transition region, respectively. The intersection of the lines 1 and 2 indicates the temperature at which the storage modulus starts to decrease abruptly and the film starts to soften, i.e., at which the film begins to be transferred to the glass transition region. This temperature is referred to as the glass transition temperature Tg (dynamic viscoelasticity).

For use as a protective film of a polarizing plate, it is preferred for the optical film to have an equilibrium water content of 0% to 4%, more preferably 0.1% to 3.5%, even more preferably 1% to 3%, at 25° C. and 80% RH irrespective of the film thickness so as not to impair the adhesion to a water soluble polymer such as polyvinyl alcohol. With an equilibrium water content of 4% or less, the film is prevented from having too much humidity dependence of retardation, which is advantageous for use as a substrate of a retardation film. The water content is measured by Karl-Fischer's method on a film specimen measuring 7 mm by 35 mm using a moisture meter CA-03 and a water vaporizer VA-05, both from Mitsubishi Chemical Corp. The measured amount of water (g) is divided by the sample mass (g) to give a water content percentage.

The moisture permeability of the film is determined at 60° C. and 95% RH in accordance with JIS Z0208. The optical film of the invention preferably has a moisture permeability of 400 to 5000 g/m²·24 hr, more preferably 400 to 4000 g/m²⁰·24 hr, even more preferably 400 to 3500 g/m²⁰·24 hr. With the moisture permeability falling within that range, both processability into a polarizing plate and durability of the resulting polarizing plate against humidity or moist heat are secured.

The optical film of the invention preferably has a tensile elastic modulus of less than 3.0 GPa, more preferably 1.0 or more and less than 3.0 GPa, even more preferably 1.2 to 2.8 GPa. The elastic modulus is determined by measuring the stress at 0.1% elongation and the stress at 0.5% elongation at a pulling rate of 10%/min at 25° C. and 60% RH by use of a universal tensile tester STM T50BP from Toyo Baldwin and calculating the elastic modulus from the slope. Elastic modulus anisotropy is obtained by changing the direction of cutting out the specimen. The angle θ between the machine direction of the film and the direction having the highest elastic modulus is preferably, but not limited to, 0±10° or 90±10°. The direction having the highest elastic modulus is also evaluated as the direction having the highest sound propagation velocity hereinafter described.

The direction having the highest sound propagation velocity in the optical film is determined as the direction in which the longitudinal wave oscillation of ultrasonic pulses propagates at the highest velocity, which is obtained using a specimen having been conditioned at 25° C. and 60% RH for 24 hours and a sonic sheet tester SST-2500 from Nomura Shoji Co.

When the optical film of the invention is used as a polarizer protective film, it can change in birefringence (Re, Rth) due to the stress accompanying the shrinkage of the polarizer. Such a change in birefringence due to the stress can be represented in terms of photoelastic coefficient. The photoelastic coefficient of the optical film is preferably 15×10⁻¹² Pa⁻¹ or less (i.e., 15 Br or less), more preferably −5×10⁻¹² Pa⁻¹ to 12×10⁻¹² Pa⁻¹ (i.e., −5 to 12 Br), even more preferably −2×10⁻¹² Pa⁻¹ to 11×10⁻¹² Pa⁻¹ (i.e., −2 to 11 Br).

Since the optical film of the invention contains a cellulose acylate, an alkali saponification treatment is one of effective means for modifying the surface of the film for use as a polarizer protective film. The optical film having been alkali saponification treated preferably has a contact angle of 55° or smaller, more preferably 50° or smaller, even more preferably 45° or smaller.

Where needed, the adhesion of the optical film to various functional layers, such as an undercoating layer and a backcoating layer, may be enhanced by various surface treatments, including a glow discharge plasma treatment, an UV irradiation treatment, a corona treatment, a flame treatment, or an acid or alkali treatment. The glow discharge plasma treatment may be a low temperature plasma treatment performed in a low pressure (10⁻³ to 20 Torr) plasma-forming gas or an atmospheric pressure plasma treatment. Examples of the plasma-forming gas that is excited to form a plasma include argon, helium, neon, krypton, xenon, nitrogen, carbon dioxide, CFCs (e.g. tetrafluoromethane), and mixtures thereof. Journal of Technical Disclosure, No. 2001-1745, pp. 30-32, issued on 2001 Mar. 15 by Japan Institute of Invention and Innovation provides further information about the surface treatments, which can preferably be used in the invention.

The optical film of the invention is useful in optical applications and also as photographic light-sensitive materials. The optical applications are particularly preferably applications to LCDs. The LCD to which the optical film is applied preferably includes a liquid crystal cell composed of a pair of electroded substrates and a liquid crystal layer sandwiched therebetween, two polarizers one on each side of the liquid crystal cell, and at least one optically compensatory film between the liquid crystal cell and the polarizer. The type of the LCD having such a configuration is preferably TN, IPS, FLC, AFLC, OCB, STN, ECB, VA or HAN.

For use in the optical applications, the optical film of the invention may be provided with various functional layers, such as an antistatic layer, a cured resin layer (transparent hardcoat layer), an antireflection layer, an adhesion enhancing layer, antiglare layer, an optically compensatory layer, an alignment layer, and a liquid crystal layer. Materials making such functional layers include surfactants, slip agents, matting agents, and so on. The details of the functional layers and materials are given in Journal of Technical Disclosure, No. 2001-1745, pp. 30-32, issued on 2001 Mar. 15 by Japan Institute of Invention and Innovation, which can preferably be used in the invention.

### [VII] Retardation Film

The retardation film according to the invention includes at least one optical film of the invention.

The optical film of the invention can be used as a retardation film. As used herein, the term “retardation film” refers to an optical element having optical anisotropy that is generally used in a display device such as an LCD and has the same meaning as, for example a phase retarder, an optically compensatory film, and an optically compensatory sheet. A retardation film is used in an LCD for the purpose of improving display contrast, viewing angle characteristics, and tint. By the use of the optical film of the invention, there is provided a retardation film having desirably adjusted retardation characteristics and excellent adhesion to a polarizer.

A plurality of the optical films of the invention may be laminated with each another, or the optical film of the invention may be laminated with other films, to make a retardation film with appropriately adjusted Re and Rth. An adhesive or a pressure-sensitive adhesive may be applied to make the laminate film.

The optical film of the invention may also be used as a support of a retardation film. In this case an optically anisotropic layer made of, e.g., a liquid crystal material is formed on the optical film as a support to provide a retardation film. The optically anisotropic layer to be provided on the optical film may be made of a composition containing a liquid crystal compound or may be formed of a birefringent polymer film or the optical film of the invention. In the case when the above described process of producing the optical film of the invention is implemented as a step following the step of forming the optically anisotropic layer, it is preferred that at least the side of the optical film (support) opposite to the side having the optically anisotropic layer provided thereon be contacted by the organic solvent.

The liquid crystal compound used to make the optically anisotropic layer is preferably a discotic liquid crystal compound or a rod-like liquid crystal compound.

Discotic liquid crystal compounds that can be used in the invention are described in various references including C. Destrade et al., Mol. Liq. Cryst., vol. 71, p. 111 (1981), The Chemical Society of Japan (ed.), Kikan Kagaku Sosetsu, No. 22, Ekisyo no Kagaku, Ch. 5, Ch. 10, Sec. 2 (1994), B. Kohne et al., Angew. Chem. Soc. Chem. Comm., p. 1794 (1985), and J. Zhang et al., J. Am. Chem. Soc., vol. 116, p. 2655 (1994). The discotic liquid crystal molecules in the optically anisotropic layer are preferably fixed in an aligned state. Fixing an aligned state is preferably effected by polymerization. JP 8-27284A teaches polymerization of discotic liquid crystal compounds. In order for discotic liquid crystal molecules to be fixed by polymerization, the molecules must have the discotic core thereof substituted with a polymerizable group. If a polymerizable group is directly bonded to the discotic core, however, it is difficult to keep the aligned state during polymerization reaction. Hence, a linking group is introduced between the discotic core and a polymerizable group. For the details of the discotic liquid crystal molecules having a polymerizable group, JP 2001-4387A can be referred to.

Examples of rod-like liquid crystal compounds that can be used in the invention include azomethines, azoxy compounds, cyanobiphenyls, cyanophenyl esters, benzoic esters, phenyl esters of cyclohexanecarboxylic acid, cyanophenylcyclohexanes, cyano-substituted phenylpyrimidines, alkoxy-substituted phenylpyrimidines, phenyldioxanes, tolans, and alkenylcyclohexylbenzonitriles. Not only low molecular liquid crystal compounds as recited but high molecular liquid crystal compounds are useful as well.

The rod-like liquid crystal molecules in the optically anisotropic layer are preferably fixed in an aligned state. Fixing an aligned state is preferably effected by polymerization. Examples of polymerizable rod-like liquid crystal compounds that can be used in the invention are described in Makromol. Chem., vol. 190, p. 2255 (1989), Advanced Materials, vol. 5, p. 107 (1993), U.S. Pat. Nos. 4,683,327, 5,622,648, and 5,770,107, WO 95/22586, 95/24455, 97/00600, 98/23580, 98/52905, and JP 1-272551A, 6-16616A, 7-110469A, 11-80081A, and 2001-328973A.

### [VIII] Polarizing Plate

The polarizing plate according to the invention includes at least one optical film of the invention or at least one retardation film of the invention.

The optical film or retardation film of the invention is useful as a polarizer protective film of the polarizing plate of the invention. That is, the polarizing plate of the invention includes a polarizer and two protective films one on each side of the polarizer, in which at least one of the protective films is the optical film or retardation film of the invention.

When the optical film of the invention is used as the protective film, the optical film is preferably subjected to a surface treatment for hydrophilization, such as the above described surface treatments and the surface treatments described in JP 6-94915A and JP 6-118232A. For example, hydrophilization is preferably achieved by a glow discharge treatment, a corona discharge treatment, or an alkali saponification treatment. An alkali saponification treatment is used most preferably.

The polarizer may be prepared by, for example, immersing a polyvinyl alcohol film in an iodine solution and stretching the film. When in using the polarizer prepared by this method, the optical film of the invention can be attached on its surface treated side directly to both sides of the polarizer with an adhesive applied therebetween. In making the polarizing plate of the invention, it is preferred that the optical film be directly attached to the polarizer in that way. Examples of suitable adhesives include aqueous solutions of polyvinyl alcohol or polyvinyl acetal (e.g., polyvinyl butyral) and latices of vinyl polymers (e.g., polybutyl acrylate). An aqueous solution of completely saponified polyvinyl alcohol is the most preferred.

An LCD generally has a liquid crystal cell disposed between a pair of polarizing plates and therefore contains a total of four polarizer-protective films. While the optical film of the invention may be used as any one or more of the four protective films, it is particularly advantageous to use the optical film of the invention as the protective film located between the polarizer and the liquid crystal layer (liquid crystal cell) of an LCD. In this application, the protective film on the side opposite to the side of the optical film of the invention may be laminated with a transparent hardcoat layer, an antiglare layer, an antireflective layer, and so on and is particularly preferably used as the polarizer-protective film closest to the viewer.

The polarizing plate composed of the polarizer and the protective film on both sides thereof may further have a protective sheet on one side thereof and a separate sheet on the other side. Both the protective sheet and the separate sheet provide the polarizing plate with a protection during shipment or inspection of the polarizing plate. The protective sheet is for protecting the side opposite to the LC panel of the polarizing plate, while the separate sheet is for covering the adhesive layer with which the polarizing plate is bonded to the LC cell.

As stated previously, an LCD usually has two polarizing plates and an LC cell therebetween. The polarizer-protective film formed of the optical film of the invention provides excellent display qualities wherever it is disposed in the LCD. Since the polarizer-protective film disposed at a position closest to a viewer is laminated with a transparent hardcoat layer, antiglare layer, an antireflection layer, and the like, it is particularly preferred to use the polarizer-protective film formed of the optical film of the invention at that position.

### [IX] LCD

The optical film, retardation film, and polarizing plate according to the invention are applicable to a wide range of display modes of LCDs, which will be described later. While the optical film, retardation film, and polarizing plate of the invention are effective in all the display modes described below, they are particularly advantageous when applied to VA and IPS mode LCDs. The LCDs may be any of transmissive, reflective, and semi-transmissive types.

### (1) TN Mode LCD

The optical film of the invention is preferably used as a support of the retardation film in a TN mode LCD having a TN mode liquid crystal cell. A TN mode liquid crystal cell and a TN mode LCD have long been known. With respect to the retardation film used in TN LCDs, refer to JP Nos. 3-9325A, 6-148429A, 8-50206A, and 9-26572A, Mori, et al., Jpn. J. Appl. Phys., vol. 36, p. 143 (1997) and ibid, vol. 36, p. 1068 (1997).

### (2) STN Mode LCD

The optical film of the invention can be used as a support of the retardation film in an STN mode LCD having an STN mode liquid crystal cell. In common STN LCDs, the liquid crystal cell contains rod-like liquid crystal molecules twisted in the range of 90° to 360°, and the product of its refractive index anisotropy Δn and the cell gap (d), i.e., Δnd is in the range of from 300 to 1500 nm. For the details of the retardation film for use in STN LCDs, reference can be made to JP 2000-105316A.

### (3) VA Mode LCD

The optical film of the invention is particularly advantageously used as a retardation film or as a support of the retardation film in a VA mode LCD having a VA mode liquid crystal cell. The VA mode LCD may have such a multi-domain structure as proposed, e.g., in JP 10-123576A. The polarizing plate using the optical film of the invention in these modes contributes to the improvement on viewing angle and contrast.

### (3) IPS Mode LCD and ECB Mode LCD

The optical film of the invention is particularly advantageously used as a retardation film, a support of the retardation film, or a protective film of a polarizer in an IPS mode LCD having an IPS mode liquid crystal cell and an ECB mode LCD having an ECB mode liquid crystal cell. In these modes of LCDs, the liquid crystal molecules are aligned substantially parallel with the substrates in a black display state. That is, the liquid crystal molecules are in parallel with the substrates with no voltage applied to achieve a black display. The polarizer having the optical film of the invention contributes to viewing angle enhancement and contrast improvement in IPS and ECB modes. In these modes, it is preferred for the optical film to have |Rth| of less than 25 nm, and it is more preferred in terms of tint changes that the optical film have Rth of 0 nm or less in the wavelength region of 450 to 650 nm.

In these applications, it is preferred that the polarizing plate on each side of the liquid crystal cell have the optical film of the invention as a polarizer-protective film on the side closer to the liquid crystal cell. It is more preferred that an optically anisotropic layer having a retardation less than twice the And of the liquid crystal layer be provided between one side of the liquid crystal cell and the protective film of the polarizing plate disposed on the same side.

### (4) OCB Mode LCD and HAN Mode LCD

The optical film of the invention is also advantageously used as a support of a retardation film in an OCB mode LCD having an OCB mode liquid crystal cell and an HAN mode LCD having an HAN mode liquid crystal cell. The retardation film used in the OCB and the ECB mode LCDs is preferably such that the direction in which the absolute retardation value is the least exists in neither an in-plane direction nor the nominal direction thereof. The optical properties of the optical film used in these LCDs are governed by the optical properties of the optically anisotropic layer, the optical properties of the support, and the configurational relationship between the optically anisotropic layer and the support. For more information on the retardation film for use in OCB and HAN mode LCDs, reference can be made to JP 9-197397A and Mori, et al., Jpn. J. Appl. Phys., vol. 38, p. 2837 (1999).

### (5) Reflective LCD

The optical film of the invention is also advantageously used as a retardation film in reflective LCDs of TN mode, STN mode, HAN mode, and GH (guest-host) mode. These display modes have long been known. TN mode reflective LCDs are described in JP 10-123478A, WO 98/48320, and Japanese Patent 3022477. The retardation film for use in reflective LCDs is described in WO 00/65384.

### (6) Other LCDs

Additionally, the optical film of the invention is used advantageously as a support of the retardation film used in ASM (axially symmetric aligned microcell) mode LCDs having an ASM mode liquid crystal cell. An ASM mode liquid crystal cell is characterized in that the cell thickness is maintained by a resin spacer the position of which is adjustable. In other respects, the ASM mode liquid crystal cell has the same properties as a TN mode liquid crystal cell. For more information about the ASM mode liquid crystal cell and the ASM mode LCD, Kume, et al., SID 98 Digest, p. 1089 (1998) can be referred to.

The optical compensation film, the polarizing plate, and the like according to the invention are applicable to spontaneously emissive display devices to improve display qualities. The spontaneously emissive display devices to which the present invention is applicable include, but are not limited to, organic ELs, PDPs, and FEDs. For example, a birefringent film having an Re of ¼λ can be applied to a spontaneous emission flat panel display to convert linearly polarized light to circularly polarized light thereby forming an anti-reflective filter.

The optical film of the invention is also applicable to a hardcoat film, an antiglare film or an anti-reflective film. Any one or more of a hardcoat layer, an antiglare layer, and an anti-reflective layer may be formed on one or both sides of the optical film for the purpose of improving visibility of flat panel displays, such as LCDs, PDPs, CRTs, and ELs. Preferred embodiments of such applications as an antiglare film, an anti-reflective film, etc. are described in detail in Journal of Technical Disclosure, No. 2001-1745, pp. 54-57. The optical film of the invention is suited for use in these embodiments.

The optical film of the invention has advantages of not only high transparency and reduced change of retardation in moist heat but also capability of being designed to have practically no optical anisotropy. Therefore, the optical film also finds use as a substitute for the glass substrates of a liquid crystal cell of an LCD, namely, transparent substrates for sealing liquid crystal material therebetween.

Seeing that the transparent substrates for sealing liquid crystals should have high gas barrier properties, a gas barrier layer may be provided on at least one side of the optical film, if necessary. While the gas barrier layer is not limited by form or material, examples of suitable gas barrier layers include a vacuum deposition layer of silicon dioxide, a coating layer of a polymer having relatively high gas barrier properties, such as a vinylidene chloride polymer or a vinyl alcohol polymer, and a stack of the organic and inorganic layers described.

For use as a transparent substrate for sealing liquid crystals, a transparent electrode may be provided to drive the liquid crystals by voltage application. The transparent electrode may be formed on at least one side of the optical film by depositing a metal or metal oxide film. A metal oxide film is preferred in terms of transparency, electric conductivity, and mechanical characteristics. An indium oxide film containing tin oxide as a main component and 2% to 15% of zinc oxide is particularly preferred. Details of the transparent electrode technology are described in JP 2001-125079A and JP 2000-227603A.

### EXAMPLES

The present invention will now be illustrated in greater detail with reference to Examples, but it should be understood that the invention is not construed as being limited thereto. Various changes and modifications may be added to the materials, amounts, ratios, operations, order of operations, and the like within the scope and spirit of the invention. In what follows, all the percents and parts are by mass unless otherwise noted.

Various characteristics were determined and evaluated by the following methods.

### (a) Degree of Substitution

The degree of acyl substitution of a cellulose acylate was determined by ¹³C-NMR analysis in accordance with the procedures described in Tezuka et al., Carbohydr. Res., 273 (1995), pp. 83-91.

### (b) Retardation

A specimen measuring 5 cm by 5 cm was cut out from five portions of a film in the cross-machine direction: the central portion, two edge portions (each away from the respective edge by 5% of the whole width), and two intermediate portions between the edge portions and the central portion. The same sampling was repeated every 100 m in the machine direction. Retardation and humidity dependence of retardation of each specimen were determined by the methods described supra, and the results obtained were averaged to obtain Re, Rth, ΔRe, and ΔRth.

ΔRe=Re(10%)−Re(80%)

ΔRth=Rth(10%)−Rth(80%)

Re(H %) and Rth(H %) are retardation values at 590 nm obtained in the same manner as described above, except that the film was conditioned at 25° C. and a relative humidity (RH) of H % for 24 hours and then subjected to the measurement at 25° C. and H % RH.

### (c) Haze

Specimens were prepared in the same manner as in (b) above. After the specimens were conditioned at 25° C. and 60% RH for 24 hours, the haze was measured with a hazemeter NDH 2000 from Nippon Denshoku Industries. The results were averaged.

### (d) Photoelastic Coefficient

A specimen measuring 1 cm by 5 cm was cut out of a film. The in-plane retardation of the specimen was determined while applying a stress to the specimen at 25° C. using an ellipsometer M-220 from JASCO Corp. The photoelastic coefficient is calculated from the change in retardation with stress.

### (e) Elastic Modulus

The elastic modulus of a film was determined by measuring the stress at 0.1% elongation and the stress at 0.5% elongation at a pulling rate of 10%/min at 25° C. and 60% RH by use of a universal tensile tester STM T50BP from Toyo Baldwin and calculating the elastic modulus from the slope.

### (f) Water Content

A specimen measuring 7 mm by 35 mm was cut out of a film and conditioned at 25° C. and 60% RH for 24 hours. The water content of the conditioned specimen was determined using a moisture meter CA-03 and a water vaporizer VA-05, both from Mitsubishi Chemical Corp. in accordance with the Karl-Fischer's method.

### (g) Dimensional Change

A film was treated at 60° C. and 90% RH for one day, and the dimensional change was measured in accordance with the method described supra.

### (h) Degree of Polarization (P)

The degree of polarization (P) was calculated from the transmission of a parallel pair of polarizing plates (Tp) and that of a crossed pair of polarizing plates (Tc′) according to equation:

Degree of polarization P=((Tp−Tc′)/(Tp+Tc′))^{0.5}

### 1. Making and Evaluation of Cellulose Acylate Films

### 1-1. Material of Polymer Solution

### 1-1-1. Cellulose Acylate

Cellulose acylates C1, C2, and C3 described below were used. On use, each cellulose acylate was dried by heating at 120° C. to reduce the water content to 0.5% or less. The cellulose acylate was used in an amount of 20 parts.

Cellulose acylate C1: powdered cellulose acetate having a substitution degree of 2.86. Viscosity average polymerization degree: 300; acetyl substitution degree at 6-position: 0.89; acetone extract: 7%; Mw/Mn: 2.3; water content: 0.2%; viscosity in 6% dichloromethane solution: 305 mPa·s; residual acetic acid content: ≦0.1%; Ca content: 65 ppm; Mg content: 26 ppm; Fe content: 0.8 ppm; sulfate ion content: 18 ppm; yellow index: 1.9; free acetic acid content: 47 ppm; average particle size: 1.5 mm (standard deviation: 0.5 mm).
Cellulose acylate C2: powdered cellulose acetate having a substitution degree of 2.94. Viscosity average polymerization degree: 290; acetyl substitution degree at 6-position: 0.91.
Cellulose acylate C3: powdered cellulose acetate having a substitution degree of 2.90. Viscosity average polymerization degree: 300; acetyl substitution degree at 6-position: 0.90.

### 1-1-2. Solvent

A mixed solvent consisting of dichloromethane, methanol, and butanol, each having a water content of 0.2% or less, in a ratio of 81/18/1 was used.

### 1-1-3. Additives

One or more additives chosen from the following list of additives: 1-1-3-1. to 1-1-3-3. and additive M shown below were used. The amount of each additive shown in Table 1 below is given in percentage to the cellulose acylate.

### 1-1-3-1. Condensation Product

A-1: Ethanediol/1,2-propanediol/adipic acid (1/1/2 by mole) condensation product with both terminals blocked with acetic ester. Number average molecular weight (Mn): 1000; hydroxyl value: 0 mgKOH/g (average number of carbon atoms of polyhydric alcohols=2.5; average number of carbon atoms of polybasic acid=6)
A-2: 1,2-Propanediol/adipic acid (1/1 by mole) condensation product with both terminals blocked with acetic ester. Mn: 1000; hydroxyl value: 0 mgKOH/g (average number of carbon atoms of polyhydric alcohol=3; average number of carbon atoms of polybasic acid=6)
A-3: Ethanediol/1,2-propanediol/adipic acid (1/1/2 by mole) condensation product. Mn: 1000; hydroxyl value: 112 mgKOH/g (average number of carbon atoms of polyhydric alcohols=2.5; average number of carbon atoms of polybasic acid=6)
A-4: 1,2-Propanediol/adipic acid (1/1 by mole) condensation product. Mn: 1000; hydroxyl value: 112 mgKOH/g (average number of carbon atoms of polyhydric alcohol=3; average number of carbon atoms of polybasic acid=6)
A-5: Ethanediol/adipic acid (1/1 by mole) condensation product. Mn: 600; hydroxyl value: 187 mgKOH/g (average number of carbon atoms of polyhydric alcohol=2; average number of carbon atoms of polybasic acid=6)
A-6: Ethanediol/adipic acid (1/1 by mole) condensation product. Mn: 1000; hydroxyl value: 187 mgKOH/g (average number of carbon atoms of polyhydric alcohol=2; average number of carbon atoms of polybasic acid=6)
A-7: Ethanediol/1,2-propanediol/adipic acid (9/1/10 by mole) condensation product with both terminals blocked with acetic ester. Mn: 1000; hydroxyl value: 0 mgKOH/g (average number of carbon atoms of polyhydric alcohols=2.1; average number of carbon atoms of polybasic acid=6)
A-8: Ethanediol/1,2-propanediol/adipic acid (3/1/4 by mole) condensation product with both terminals blocked with acetic ester. Mn: 1000; hydroxyl value: 0 mgKOH/g (average number of carbon atoms of polyhydric alcohols=2.25; average number of carbon atoms of polybasic acid=6)
A-9: Ethanediol/1,3-propanediol/adipic acid (1/1/2 by mole) condensation product with both terminals blocked with acetic ester. Mn: 950; hydroxyl value: 0 mgKOH/g (average number of carbon atoms of polyhydric alcohols=2.5; average number of carbon atoms of polybasic acid=6)
A-10: Ethanediol/1,2-propanediol/adipic acid (1/1/2 by mole) condensation product with both terminals blocked with methyl ester. Mn: 1000; hydroxyl value: 0 mgKOH/g (average number of carbon atoms of polyhydric alcohols=2.5; average number of carbon atoms of polybasic acid=6)
A-11: Ethanediol/formic acid (1/1 by mole) condensation product with both terminals blocked with formic ester. Mn: 100; hydroxyl value: 0 mgKOH/g (average number of carbon atoms of polyhydric alcohol=2; average number of carbon atoms of polybasic acid=1)
A-12: Ethanediol/1,2-propanediol/adipic acid/terephthalic acid (1/1/1/1 by mole) condensation product with both terminals blocked with acetic ester. Mn: 1200; hydroxyl value: 0 mgKOH/g (average number of carbon atoms of polyhydric alcohols=2.5; average number of carbon atoms of polybasic acids=7)
A-13: Ethanediol/adipic acid (1/1 by mole) condensation product with both terminals blocked with acetic ester. Mn: 600; hydroxyl value: 0 mgKOH/g (average number of carbon atoms of polyhydric alcohol=2; average number of carbon atoms of polybasic acid=6)
A-14: Ethanediol/succinic acid (1/1 by mole) condensation product. Mn: 1000; hydroxyl value: 112 mgKOH/g (average number of carbon atoms of polyhydric alcohol=2; average number of carbon atoms of polybasic acid=4)
A-15: Ethanediol/1,3-butanediol/adipic acid (3/1/4 by mole) condensation product with both terminals blocked with acetic ester. Mn: 1000; hydroxyl value: 0 mgKOH/g (average number of carbon atoms of polyhydric alcohols=2.5; average number of carbon atoms of polybasic acid=6)
A-16: Ethanediol/1,4-butanediol/succinic acid (1/2/3 by mole) condensation product. Mn: 2000 (average number of carbon atoms of polyhydric alcohols=3.33; average number of carbon atoms of polybasic acid=4)
A-17: Diethylene glycol/succinic acid/adipic acid (2/1/1 by mole) condensation product. Mn: 2500 (average number of carbon atoms of polyhydric alcohol=4; average number of carbon atoms of polybasic acids=5)
A-18: Ethanediol/dipropylene glycol/adipic acid (1/1/2 by mole) condensation product with both terminals blocked with acetic ester. Mn: 1000 (average number of carbon atoms of polyhydric alcohols=4; average number of carbon atoms of polybasic acid=6)
A-19: Ethanediol/1,2-propanediol/adipic acid (7/3/10 by mole) condensation product with both terminals blocked with acetic ester. Mn: 1000; hydroxyl value: 0 mgKOH/g (average number of carbon atoms of polyhydric alcohols=2.3; average number of carbon atoms of polybasic acid=6)

Of the polyhydric alcohols constituting the condensation products A-1 to A-19, those containing at least three carbon atoms bonded together without being interrupted by any other atom are 1,2-propanediol, 1,3-propanediol, 1,3-butanediol, 1,4-butanediol, and dipropylene glycol.

### 1-1-3-2. Compound Having Repeating Unit

B-1: Methyl methacrylate/methyl acrylate (1/1 by mole) addition polymer. Mn: 2000.
1-1-3-3. Compound that Improves Moist Heat Stability of Retardation (Rth Stability Improving Agent)

### N1: Compound of Formula:

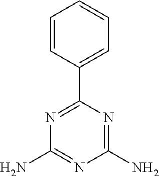

### N2: Compound of Formula:

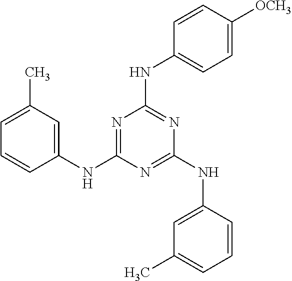

### N3: Compound of Formula:

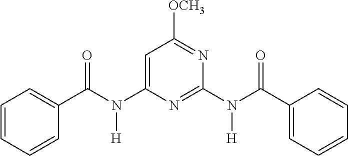

### N4: Compound of Formula:

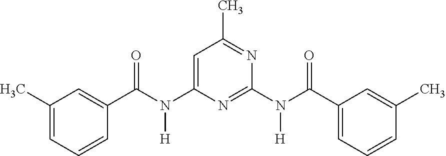

### 1-1-3-4. Other Additive

M: Silicon dioxide particles (particle size: 20 nm; Mohs hardness: about 7), used in an amount of 0.02 parts.

### 1-2. Dissolution

The solvent and the additives shown in Table 1 were put in a 400 L-volume stainless steel dissolver tank equipped with a stirring means and jacketed with circulated cooling water. While the mixture in the tank was dispersed by stirring, the cellulose acylate was slowly added thereto. After completion of the addition, the mixture was stirred at room temperature for 2 hours, swollen for 3 hours, and again stirred to prepare a cellulose acylate solution. The composition of the solution was as follows:

| Cellulose acylate | 20 | parts |
|---|---|---|
| Solvent | 100 | parts |
| Additive shown in Table 1 | shown in Table 1 | |
| | (% relative to cellulose acylate) | |
| Additive M | 0.02 | parts |

The stirring means consisted of a dissolver-type eccentric stirring shaft and a concentric stirring shaft on which an anchor blade was mounted. The stirring was performed by rotating the eccentric stirring shaft at a peripheral speed of 15 m/sec (shear stress: 5×10⁴ kgf/m/sec² (4.9×10⁵ N/m/sec²)) and the concentric stirring shaft at a peripheral speed of 1 m/sec (shear stress: 1×10⁴ kgf/m/sec² (9.8×10⁴ N/m/sec²)). In carrying out the swelling, the eccentric stirring shaft was stopped, and the concentric stirring shaft was rotated at a peripheral speed of 0.5 m/sec.

The swollen solution from the tank was then heated to 50° C. through a jacketed pipe and then heated up to 90° C. under a pressure of 2 MPa to accomplish complete dissolution. The total heating time was 15 minutes. The filter, housing, and piping used in the heating were made of a highly anti-corrosive hastelloy and jacketed with a circulated heat insulating medium. The solution was then cooled to 36° C.

### 1-3. Filtration

The resulting cellulose acylate solution was filtered first through filter paper having an absolute filtration rating of 10 μm (#63, from Toyo Roshi) and then through a sintered metal filter having an absolute filtration rating of 2.5 μm (FH025, from Pall Corp.) to prepare a dope.

### 1-4. Film Formation

Cellulose acylate films shown in Table 1, numbered 1 through 48, were prepared using film formation processing F1 or F2 described below. All the films obtained had a residual solvent content of 0.3% or less. Film No. 35 (Example of invention) was prepared by stretching film No. 5 (Example of the invention) in according with stretching processing F3 below.

### Film Formation Processing F1:

The dope was heated to 30° C. and cast through a casting head on a mirror-finished stainless steel drum having a 3 m diameter, set at −7° C. and rotating at a speed of 50 m/min with a coating width of 200 cm. The environmental spatial temperature of the whole casting zone was set at 15° C. The cellulose acylate web thus formed on the drum was peeled off the drum when its leading end was 50 cm short of the end of the casting zone and clamped on both edges thereof in a pin tenter. The web immediately after removal from the drum was found to have a residual solvent content of 280% as calculated from formula:

Residual solvent content (%)={(M−N)/N}×100

where M is the mass of the film immediately before it enters a stretch zone; and N is the mass of the film measured after the film immediately before entering a stretch zone is dried at 110° C. for 3 hours.

The web as held along its opposite edges by the pin tenter was dried at 100° C. for 5 minutes and, after it was removed from the pin tenter, opposite edges of the web were cut off by NT® cutters set on both edge portions. The web was further dried at 70° C. for 15 minutes while being advanced between rollers to yield a web of cellulose acylate film.

### Film Formation Processing F2:

The cellulose acylate film obtained in processing F2 was preheated to 85° C. while being advanced between rollers, bought into contact with steam adjusted to 85° C. and 85% RH for 1 minute while being conveyed under a tension of 60 N/m, dried in a drying zone at 70° C. for 2 minutes, and wound up into a roll of 3900 m.

### Stretch Processing F3:

The cellulose acylate film was held on both edges thereof by tenter clips and stretched 5% in a direction perpendicular to the machine direction at 60° C.

### 2. Making and Evaluation of Polarizing Plate

### 2-1. Making Polarizing Plate

### 2-1-1. Preparation of Protective Films (Saponification)

Each of the cellulose acylate films prepared above and Fuji Tack TD60UL from Fujifilm was immersed in a 4.5 mol/L aqueous solution of sodium hydroxide (saponification bath) at 37° C. for 1 minute. The film taken out of the saponification bath was washed with water, immersed in a 0.05 mol/L sulfuric acid aqueous solution for 30 seconds, and again passed through a washing bath. Surface water was removed from the film tree times with an air knife and dried in a drying zone at 70° C. for a retention time of 15 seconds to prepare a saponified film.

### 2-1-2. Making Polarizer

A 20 μm thick polarizer was prepared in accordance with the procedures described in Example 1 of JP 2001-141926A. Specifically, the film was longitudinally stretched by means of two pairs of nip rollers rotating at different peripheral speeds.

### 2-1-3. Making Polarizing Plate

The polarizer prepared above was sandwiched in between one of the film Nos. 1 to 48 having been saponified and the saponified Fuji Tack TD60UL. The three webs of film were joined together roll-to-roll via a 3% polyvinyl alcohol (PVA-117H, from Kuraray) aqueous solution as an adhesive with the axis of polarization and the longitudinal direction of the films crossing at right angles to make a polarizing plate.

### 2-2. Evaluation of Polarizing Plate

### (i) Initial Polarization

The initial polarization P of each polarizing plate prepared was computed by the method previously described. All the polarizing plates were found to have an initial polarization of 99.9%.

(ii) Stability of Polarization with Time

The polarizing plate was attached to a glass plate on the side opposite to Fuji Tack TD60UL via a pressure-sensitive adhesive and allowed to stand at 60° C. and 90% RH for 500 hours. Thereafter, the polarization P of the polarizing plate was determined by the method previously described. As a result,

all the polarizing plates were found to have a polarization of 99.9%.
(iii) Moist Heat Stability of Rth

The polarizing plate was attached to a glass plate on the side opposite to Fuji Tack TD60UL via a transferred pressure-sensitive adhesive and allowed to stand at 80° C. and 90% RH for 130 hours. The Fuji Tack TD60UL and the polarizer were stripped off the polarizing plate. After visually ascertaining the transparency of the film remaining on the glass plate, the retardation was determined by the method described above. The moist heat stability of Rth was calculated according to the following formula. The results obtained are shown in Table 1. In the formula, the Rth is a value measured for light of 590 nm, and “Rth of film immediately after film formation” is a value measured at 25° C. and 60% RH.

Moist heat stability of Rth=(Rth of film remaining on glass plate)−(Rth of film immediately after film formation) (nm)

### (iv) Performance of Polarizing Plate Mounted on LCDs

(iv-i) IPS LCD

A commercially available 42-inch slim LCD TV set of IPS mode was modified by replacing each of the polarizing plates on both sides of the liquid crystal cell with the polarizing plate obtained above with the side of film Nos. 1 to 48 facing the liquid crystal cell using a pressure-sensitive adhesive. The modified TV set was maintained at 50° C. and 80% RH for 5 days and then transferred into an environment of 25° C. and 60% RH, where it was left on 24 hours in a black display mode. After that, the screen was visually observed from the front to evaluate brightness unevenness in a black display mode on the following rating system. The results of evaluation are shown in Table 1.

A: Almost no unevenness is observed under an illuminance of 100 lx.
B: Slight unevenness is observed under an illuminance of 100 lx.
C: Clear unevenness is observed under an illuminance of 100 lx.
D: Clear unevenness is observed under an illuminance of 300 lx.
(iv-ii) VA LCD A commercially available 42-inch slim LCD TV set of VA mode was modified by replacing the polarizing plate on the backlight side of the liquid crystal cell with the polarizing plate having film No. 32 with the side of film No. 32 facing the liquid crystal cell using a pressure-sensitive adhesive. The modified TV set was maintained at 50° C. and 80% RH for 5 days and then transferred into an environment of 25° C. and 60% RH, where it was left on in a black display mode. After 24 hours, the screen was visually observed from the front to evaluate brightness unevenness in a black display mode to find that almost no unevenness was observed under an illuminance of 100 lx.

TABLE 1

| | | Additives* | | | | | | | | | | |
|---|---|---|---|---|---|---|---|---|---|---|---|---|
| | | | | | | Rth Stability | | | | | | |
| | | Additive 1 | | Additive 2 | | Improving Agent | | | Film Characteristics | | | |
| Film | Cellulose | | Amount | | Amount | | Amount | | Thickness | Re | Rth | ΔRe |
| No. | Acylate | Kind | (%) | Kind | (%) | Kind | (%) | Processing | (μm) | (nm) | (nm) | (nm) |
| 1 | C1 | A-1 | 15 | — | — | — | — | F1 | 50 | 0 | 11 | 0 |
| 2 | C1 | A-1 | 20 | — | — | — | — | F1 | 50 | 0 | 6 | 0 |
| 3 | C1 | A-1 | 31 | — | — | — | — | F1 | 50 | 0 | −6 | 0 |
| 4 | C1 | A-1 | 40 | — | — | — | — | F1 | 30 | 0 | −10 | 0 |
| 5 | C1 | A-1 | 40 | — | — | — | — | F1 | 50 | 0 | −12 | 0 |
| 6 | C1 | A-1 | 40 | — | — | — | — | F2 | 50 | 0 | −9 | 0 |
| 7 | C1 | A-1 | 40 | — | — | — | — | F1 | 60 | 0 | −14 | 0 |
| 8 | C1 | A-1 | 40 | — | — | N1 | 0.5 | F1 | 50 | 0 | −11 | 0 |
| 9 | C1 | A-1 | 31 | B-1 | 20 | — | — | F1 | 50 | 0 | −15 | 0 |
| 10 | C1 | A-1 | 50 | — | — | — | — | F1 | 50 | 0 | −16 | 0 |
| 11 | C1 | A-2 | 40 | — | — | — | — | F1 | 50 | 0 | −7 | −1 |
| 12 | C1 | A-3 | 40 | — | — | — | — | F1 | 50 | 0 | −9 | 0 |
| 13 | C1 | A-4 | 40 | — | — | — | — | F1 | 50 | 0 | −6 | 0 |
| 14 | C1 | A-5 | 50 | — | — | — | — | F1 | 50 | 0 | −25 | 0 |
| 15 | C1 | A-6 | 15 | — | — | — | — | F1 | 50 | 0 | 9 | 0 |
| 16 | C1 | A-6 | 30 | — | — | — | — | F1 | 50 | 0 | −5 | 0 |
| 17 | C1 | A-6 | 40 | — | — | — | — | F1 | 50 | 0 | −13 | 0 |
| 18 | C1 | A-7 | 40 | — | — | — | — | F1 | 50 | 0 | −14 | 0 |
| 19 | C1 | A-8 | 40 | — | — | — | — | F1 | 50 | 0 | −14 | 0 |
| 20 | C1 | A-9 | 40 | — | — | — | — | F1 | 50 | 0 | −12 | 0 |
| 21 | C1 | A-10 | 40 | — | — | — | — | F1 | 50 | 0 | −11 | 0 |
| 22 | C1 | A-1 | 40 | — | — | N2 | 0.5 | F1 | 50 | 0 | −6 | 0 |
| 23 | C1 | A-1 | 53 | — | — | N2 | 2 | F1 | 50 | 0 | −4 | 0 |
| 24 | C1 | A-8 | 40 | — | — | N2 | 0.5 | F1 | 50 | 0 | −5 | 0 |
| 25 | C1 | A-8 | 53 | — | — | N2 | 1.5 | F1 | 50 | 0 | −7 | 0 |
| 26 | C1 | A-8 | 53 | — | — | N2 | 2 | F1 | 50 | 0 | −4 | 0 |
| 27 | C2 | A-1 | 50 | — | — | N2 | 2 | F1 | 50 | 0 | −7 | 0 |
| 28 | C2 | A-8 | 50 | — | — | N2 | 2 | F1 | 50 | 0 | −7 | 0 |
| 29 | C3 | A-8 | 50 | — | — | N2 | 2 | F1 | 50 | 0 | −6 | 0 |
| 30 | C1 | A-1 | 35 | A-12 | 15 | — | — | F1 | 50 | 0 | 34 | 0 |
| 31 | C1 | A-11 | 30 | — | — | — | — | F1 | 50 | 0 | −25 | 0 |
| 32 | C1 | A-1 | 35 | A-12 | 15 | — | — | F1 | 60 | 0 | 41 | 0 |
| 33 | C1 | A-13 | 50 | — | — | — | — | F1 | 50 | 0 | −16 | 0 |
| 34 | C1 | A-14 | 40 | — | — | — | — | F1 | 50 | 0 | −18 | 0 |
| 35 | C1 | A-1 | 40 | — | — | — | — | F1/ | 47 | 0 | −10 | 0 |
| | | | | | | | | F3 | | | | |
| 36 | C1 | A-15 | 45 | — | — | — | — | F1 | 50 | 0 | −13 | 0 |
| 37 | C1 | A-16 | 40 | — | — | — | — | F1 | 50 | 0 | −10 | 0 |
| 38 | C1 | A-16 | 20 | — | — | — | — | F1 | 50 | 0 | 2 | 0 |
| 39 | C1 | A-17 | 40 | — | — | — | — | F1 | 50 | 0 | −6 | 0 |
| 40 | C1 | A-18 | 40 | — | — | — | — | F1 | 50 | 0 | −10 | 0 |
| 41 | C1 | A-1 | 34 | | | N3 | 0.5 | F1 | 50 | 0 | −6 | 0 |
| 42 | C1 | A-1 | 39 | | | N3 | 0.5 | F1 | 50 | 0 | −8 | 0 |
| 43 | C1 | A-1 | 33 | | | N3 | 2 | F1 | 50 | 0 | −2 | 0 |
| 44 | C1 | A-1 | 38 | | | N3 | 2 | F1 | 50 | 0 | −4 | 0 |
| 45 | C1 | A-1 | 34 | | | N4 | 0.5 | F1 | 50 | 0 | −5 | 0 |
| 46 | C1 | A-1 | 38 | | | N4 | 2 | F1 | 50 | 0 | −3 | 0 |
| 47 | C1 | A-19 | 45 | | | N2 | 0.8 | F1 | 50 | 0 | −6 | 0 |
| 48 | C1 | A-19 | 50 | | | N2 | 1 | F1 | 50 | 0 | −6 | 0 |

| | Film Characteristics | | | | | Polarizing Plate | | |
|---|---|---|---|---|---|---|---|---|
| | | | Water | Elastic | Photo- | Moist Heat | | |
| Film | ΔRth | Dimensional | Content | Modulus | elasticity | Stability | Light | |
| No. | (nm) | Change (%) | (%) | (GPa) | (Br) | of Rth | Unevenness | Remark |
| 1 | 14 | 0.0 | 3.8 | 3.6 | 10 | −7 | D | comparison |
| 2 | 12 | 0.1 | 3.3 | 3.3 | 10 | −2 | B | comparison |
| 3 | 7 | 0.3 | 2.6 | 2.8 | 10 | 2 | A | example |
| 4 | 3 | 0.4 | 2.2 | 2.2 | 10 | 2 | A | example |
| 5 | 4 | 0.4 | 2.3 | 2.2 | 10 | 3 | A | example |
| 6 | 4 | 0.0 | 2.3 | 2.2 | 10 | 1 | A | example |
| 7 | 4 | 0.4 | 2.3 | 2.2 | 10 | 2 | A | example |
| 8 | 3 | 0.4 | 2.3 | 2.2 | 10 | 0 | A | example |
| 9 | 4 | 0.4 | 2.1 | 2.5 | 8 | 2 | A | example |
| 10 | 4 | 0.5 | 2.0 | 1.7 | 10 | 3 | A | example |
| 11 | 6 | 0.4 | 2.3 | 2.2 | 10 | 0 | A | example |
| 12 | 6 | 0.4 | 2.9 | 2.0 | 11 | 4 | A | example |
| 13 | 6 | 0.4 | 2.8 | 2.0 | 11 | 1 | A | example |
| 14 | 3 | 0.8 | 2.9 | 1.5 | 9 | 38 | A | comparison |
| 15 | 15 | 0.0 | 4.2 | 3.4 | 10 | −2 | D | comparison |
| 16 | 8 | 0.3 | 3.3 | 2.8 | 10 | 15 | B | comparison |
| 17 | 3 | 0.4 | 2.9 | 2.2 | 10 | 24 | A | comparison |
| 18 | 3 | 0.4 | 2.3 | 2.2 | 10 | 9 | A | example |
| 19 | 3 | 0.4 | 2.3 | 2.2 | 10 | 5 | A | example |
| 20 | 4 | 0.4 | 2.3 | 2.2 | 10 | 2 | A | example |
| 21 | 4 | 0.3 | 2.3 | 2.2 | 10 | 3 | A | example |
| 22 | 4 | 0.3 | 2.3 | 2.2 | 11 | −2 | A | example |
| 23 | 2 | 0.4 | 1.9 | 1.5 | 11 | −8 | A | example |
| 24 | 4 | 0.3 | 2.3 | 2.2 | 11 | −3 | A | example |
| 25 | 3 | 0.4 | 1.9 | 1.6 | 10 | −8 | A | example |
| 26 | 3 | 0.4 | 1.9 | 1.6 | 11 | −10 | A | example |
| 27 | 2 | 0.3 | 1.9 | 1.8 | 11 | −6 | A | example |
| 28 | 3 | 0.2 | 1.9 | 1.9 | 10 | −8 | A | example |
| 29 | 3 | 0.3 | 2.0 | 1.8 | 11 | −6 | A | example |
| 30 | 6 | 0.3 | 2.5 | 1.9 | 13 | 5 | A | example |
| 31 | 3 | 0.4 | 2.6 | 2.6 | 9 | 103 | B | comparison |
| 32 | 7 | 0.2 | 2.5 | 1.9 | 13 | 6 | A | example |
| 33 | 3 | 0.5 | 1.9 | 1.6 | 10 | 22 | A | comparison |
| 34 | 2 | 0.4 | 3.0 | 2.1 | 10 | 124 | B | comparison |
| 35 | 5 | 4.1 | 2.3 | 2.2 | 10 | 3 | B | example |
| 36 | 3 | 0.4 | 2.2 | 1.9 | 10 | 1 | A | example |
| 37 | 5 | 0.3 | 2.9 | 2.2 | 10 | 12 | B | comparison |
| 38 | 13 | 0.1 | 3.8 | 3.2 | 11 | −2 | C | comparison |
| 39 | 5 | 0.4 | 2.9 | 2.1 | 11 | 28 | A | comparison |
| 40 | 4 | 0.4 | 2.3 | 2.2 | 10 | 3 | A | example |
| 41 | 3 | 0.1 | 2.5 | 2.6 | 11 | −4 | A | example |
| 42 | 2 | 0.3 | 2.3 | 2.2 | 10 | −6 | A | example |
| 43 | 2 | 0.1 | 2.5 | 2.6 | 11 | −8 | A | example |
| 44 | 2 | 0.3 | 2.3 | 2.2 | 10 | −7 | A | example |
| 45 | 3 | 0.2 | 2.5 | 2.6 | 10 | −8 | A | example |
| 46 | 2 | 0.3 | 2.3 | 2.2 | 11 | −6 | A | example |
| 47 | 4 | 0.2 | 2.2 | 1.9 | 11 | −4 | A | example |
| 48 | 3 | 0.4 | 2.0 | 1.6 | 11 | −7 | A | example |

*The amounts of the additives are by mass % based on the mass of the cellulose acylate (100%).

All of film Nos. 1 through 48 were excellent in transparency, having a haze of 0.5% or less. The results in Table 1 show the following: The light leakage problem with LCDs is sufficiently eliminated by the use of the polarizing plates prepared using the optical films of the invention which contain more than 30% of the specific condensation product relative to a cellulose ester. The changes of Rth when these polarizing plates are maintained under a moist heat condition are markedly reduced by the addition of a condensation product containing a polyhydric alcohol component having 3 or more carbon atoms. The Rth changes due to moist heat are further reduced by reducing the hydroxyl value of the condensation product, reducing the dimensional change of the film, or adding an Rth stability improving agent. While not shown in Table 1, it was confirmed that the films of the invention which contained the additive A-1 produce an additional favorable effect that dust generation during film edge cutting following removal from a pin tenter is reduced as compared with the comparative films containing the additive A-5 or A-6.

In the film formation processing to prepare comparative film No. 31, the additive adhered to the inner walls of the drying zone casting during the drying step. The LCD TV having film No. 31 incorporated into the polarizing plates showed unevenness of different type from the light unevenness as might be observed on LCD TVs having the other films, and this LCD TV suffered from noticeable light leakage over the entire display area. The LCD TV having film No. 35 showed local light leakage in the peripheral portion of the display area. It was demonstrated that the LCD TVs using the polarizing plates of the invention having reduced Rth changes are highly reliable, suffering from no change in tint even when maintained in moist heat.

What is claimed is:

1. An optical film comprising a cellulose ester and more than 30% by mass, relative to the cellulose ester, of a condensation product of at least one polyhydric alcohol having an average of 2.01 or more carbon atoms and at least one polybasic acid having an average of 4.10 or more carbon atoms, at least one of the at least one polyhydric alcohol containing at least three carbon atoms bonded together without being interrupted by any other atom.

2. The optical film according to claim 1, wherein at least one of the carbon atoms bonded to the hydroxyl groups of the polyhydric alcohol is a secondary or tertiary carbon atom.

3. The optical film according to claim 1, wherein the condensation product has a hydroxyl value of less than 40 mgKOH/g.

4. The optical film according to claim 1, which further comprises a compound that improves moist heat stability of retardation.

5. The optical film according to claim 4, wherein the compound that improves moist heat stability of retardation is a compound having basicity.

6. The optical film according to claim 5, wherein the compound having basicity contains at least one basic functional group selected from primary amino, secondary amino, tertiary amino, quaternary ammonium, pyridyl, pyrimidinyl, pyrazinyl, guanidino, imino, imidazolyl, indole, and purine.

7. The optical film according to claim 4, wherein the compound that improves moist heat stability of retardation comprises a compound represented by formula (1) or (2): 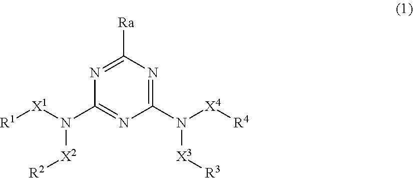
wherein Ra represents an optionally substituted alkyl group, an optionally substituted alkenyl group, an optionally substituted alkynyl group, an optionally substituted heterocyclic group, or an optionally substituted aryl group; X¹, X², X³, and X⁴ each independently represent a single bond or a divalent linking group; R¹, R², R³, and R⁴ each independently represent hydrogen, an optionally substituted alkyl group, an optionally substituted alkenyl group, an optionally substituted alkynyl group, an optionally substituted aryl group, an optionally substituted acyl group, or an optionally substituted heterocyclic group. 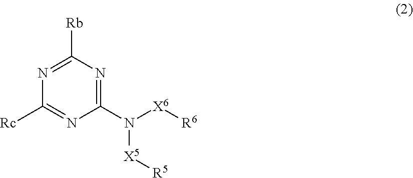
wherein Rb and Rc each independently represent an optionally substituted alkyl group, an optionally substituted alkenyl group, an optionally substituted alkynyl group, an optionally substituted heterocyclic group, or an optionally substituted aryl group; X⁵ and X⁶ each independently represent a single bond or a divalent linking group; and R⁵ and R⁶ each independently represent hydrogen, an optionally substituted alkyl group, an optionally substituted alkenyl group, an optionally substituted alkynyl group, an optionally substituted aryl group, an optionally substituted acyl group, or an optionally substituted heterocyclic group.

8. The optical film according to claim 1, further comprising an addition polymer of an acrylic ester or an addition polymer of a methacrylic ester.

9. The optical film according to claim 1, having a tensile elastic modulus of less than 3 GPa.

10. The optical film according to claim 1, having a ΔRth of from −30 to 30 nm, the ΔRth being defined by the following formula:
ΔRth=Rth(10%)−Rth(80%)
where Rth(H %) represents the Rth of the film measured at 25° C. and a relative humidity of H %.

11. The optical film according to claim 1, having a dimensional change of 3% or less when treated at 60° C. and 90% RH for one day.

12. A retardation film comprising the optical film according to claim 1.

13. A polarizing plate comprising the optical film according to claim 1.

14. An image display device comprising the optical film according to claim 1.
